(19) United States
(12) Patent Application Publication
(10) Pub. No.: US 2017/0124592 A1
(43) Pub. Date: May 4, 2017

(54) INFORMATION TRANSMISSION APPARATUS, CONTROL METHOD THEREOF, SYSTEM, AND STORAGE MEDIUM

(71) Applicant: CANON KABUSHIKI KAISHA, Tokyo (JP)

(72) Inventor: Yuji NAYA, Kawasaki-shi (JP)

(21) Appl. No.: 15/300,666

(22) PCT Filed: May 13, 2015
(86) PCT No.: PCT/JP2015/064394

§ 371 Date: Sep. 29, 2016

(30) Foreign Application Priority Data
May 20, 2014 (JP) 2014-104515

(51) Int. Cl. G06Q 30/02; G01C 21/10; G01S 5/02

(52) U.S. Cl. CPC G06Q 30/0261; G01S 5/0284; G01C 21/10

(57) ABSTRACT

A system includes an information transmission apparatus and a mobile terminal, the information transmission apparatus comprises: transmission means for periodically transmitting identification information used to cause the mobile terminal to display predetermined information; detection means for detecting that the information transmission apparatus has moved; and stopping means for, when the detection means detects that the information transmission apparatus has moved, stopping transmission of the identification information by the transmission means, and the mobile terminal comprises: reception means for receiving the identification information; and display means for displaying information corresponding to the identification information when the reception means receives the identification information.

### TECHNICAL FIELD

The present invention relates to an information transmission apparatus, a control method thereof, a system, and a storage medium.

### BACKGROUND ART

In recent years, various services using a user's real-time location have been rolled out. For example, there is a service for displaying the current location of an information terminal held by a user on a map for walking navigation. Also exists a service that registers information in advance in association with a place and notifies a user of the registered information when he/she actually comes close to the place. In these services, the location of the information terminal held by the user is measured using a positioning technology such as GPS (Global Positioning System). In GPS, however, it is difficult for a device in a building to receive a radio wave from a satellite. To solve this problem, there is proposed, for example, a method of determining the location of an information terminal held by a user based on the principle of triangulation using the radio field intensity of a wireless access point whose location is registered in advance (Japanese Patent Laid-Open No. 2010-190629).

There is also proposed a technique of placing, at an arbitrary point indoors or outdoors, a compact battery-driven beacon (information transmission apparatus) that broadcasts radio waves and delivers useful information to a customer who comes close to the beacon (Estimote Inc., Estimote Beacon, [online]. Estimote Inc., [searched Nov. 26, 2013, Internet <http://estimote.com/>).

According to the technique disclosed in Japanese Patent Laid-Open No. 2010-190629, the location of the terminal held by the user can be determined by the radio field intensities of a plurality of wireless access points. However, this technique needs to register the locations of the plurality of placed wireless access points in advance. If the locations of the wireless access points change, it is impossible to correctly determine the location of the terminal held by the user.

According to the technique of Estimote Beacon of Estimote Inc., the compact battery-driven beacon can deliver the information of an article of commerce to an information terminal near the beacon. However, if the beacon is unintentionally moved together with, for example, a shelf, the article of commerce that is actually present in the place differs from that of the delivered information.

### SUMMARY OF INVENTION

The present invention has been made in consideration of the above-described problems, and causes an information transmission apparatus to detect the movement of itself, thereby properly maintaining the location of the apparatus.

According to one aspect of the present invention, there is provided a system including an information transmission apparatus and a mobile terminal, the information transmission apparatus comprising: transmission means for periodically transmitting identification information used to cause the mobile terminal to display predetermined information; detection means for detecting that the information transmission apparatus has moved; and stopping means for, when the detection means detects that the information transmission apparatus has moved, stopping transmission of the identification information by the transmission means, and the mobile terminal comprising: reception means for receiving the identification information; and display means for displaying information corresponding to the identification information when the reception means receives the identification information.

According to another aspect of the present invention, there is provided a system including an information transmission apparatus and a mobile terminal, the information transmission apparatus comprising: transmission means for periodically transmitting identification information used to cause the mobile terminal to display predetermined information; detection means for detecting that the information transmission apparatus has moved; and change means for, when the detection means detects that the information transmission apparatus has moved, changing the information to be periodically transmitted by the transmission means, and the mobile terminal comprising: reception means for receiving the identification information; and display means for displaying information corresponding to the identification information when the reception means receives the identification information.

According to another aspect of the present invention, there is provided an information transmission apparatus comprising: transmission means for periodically transmitting identification information used to cause a mobile terminal to display predetermined information; detection means for detecting that the information transmission apparatus has moved; and stopping means for, when the detection means detects that the information transmission apparatus has moved, stopping transmission of the identification information by the transmission means.

According to another aspect of the present invention, there is provided an information transmission apparatus comprising: transmission means for periodically transmitting identification information used to cause a mobile terminal to display predetermined information; detection means for detecting that the information transmission apparatus has moved; and change means for, when the detection means detects that the information transmission apparatus has moved, changing the information to be periodically transmitted by the transmission means.

According to another aspect of the present invention, there is provided a control method of an information transmission apparatus, comprising: a transmission step of periodically transmitting identification information used to cause a mobile terminal to display predetermined information; a detection step of detecting that the information transmission apparatus has moved; and a stopping step of, when it is detected in the detection step that the information transmission apparatus has moved, stopping transmission of the identification information in the transmission step.

According to another aspect of the present invention, there is provided a storage medium storing a program that causes a computer to function as: transmission means for periodically transmitting identification information used to cause a mobile terminal to display predetermined information; detection means for detecting that the computer has moved; and stopping means for, when the detection means detects that the computer has moved, stopping transmission of the identification information by the transmission means.

According to another aspect of the present invention, there is provided a control method of an information transmission apparatus, comprising: a transmission step of periodically transmitting identification information used to cause a mobile terminal to display predetermined information; a detection step of detecting that the information transmission apparatus has moved; and a change step of, when it is detected in the detection step that the information transmission apparatus has moved, changing the information to be periodically transmitted in the transmission step.

According to another aspect of the present invention, there is provided a storage medium storing a program that causes a computer to function as: transmission means for periodically transmitting identification information used to cause a mobile terminal to display predetermined information; detection means for detecting that the computer has moved; and change means for, when the detection means detects that the computer has moved, changing the information to be periodically transmitted by the transmission means.

According to the present invention, it is possible to appropriately maintain location information even if a location information transmission apparatus itself is moved.

Further features of the present invention will become apparent from the following description of exemplary embodiments (with reference to the attached drawings).

### BRIEF DESCRIPTION OF DRAWINGS

FIG. 1 is an overall conceptual view showing the relationship between an information transmission apparatus, a mobile terminal, and a management server;

FIG. 2 is a hardware block diagram of the information transmission apparatus, the mobile terminal, and the management server;

FIG. 3 is a software block diagram of the information transmission apparatus, the mobile terminal, and the management server;

FIGS. 4A, 4B, 4C, and 4D are views showing examples of the database and the map of the management server;

FIG. 5 is a flowchart of the information transmission apparatus according to the first embodiment;

FIG. 6 is a flowchart of the mobile terminal and the management server according to the first embodiment;

FIGS. 7A, 7B, and 7C are views showing an example of screen transition of the mobile terminal according to the first embodiment;

FIG. 8 is a flowchart of an information transmission apparatus according to the second embodiment;

FIG. 9 is a flowchart of a mobile terminal and a management server according to the second embodiment;

FIG. 10 is a flowchart of packet information processing of the management server according to the second embodiment;

FIGS. 11A and 11B are flowcharts of a mobile terminal and a management server according to the third embodiment;

FIGS. 12A, 12B, 12C, 12D, and 12E are views showing an example of screen transition of the mobile terminal according to the third embodiment;

FIGS. 13A and 13B are views showing examples of the database and the map of the management server according to the third embodiment;

FIGS. 14A and 14B are flowcharts of a mobile terminal and a management server according to the fourth embodiment;

FIG. 15 is a flowchart of packet information processing of the management server according to the fourth embodiment;

FIGS. 16A, 16B, 16C, and 16D are views showing examples of the database and the map of the management server according to the fourth embodiment;

FIGS. 17A and 17B are flowcharts of a mobile terminal and a management server according to the fifth embodiment;

FIGS. 18A, 18B, and 18C are views showing an example of screen transition of the mobile terminal according to the fifth embodiment;

FIGS. 19A and 19B are views showing examples of the database of the management server according to the fifth embodiment;

FIG. 20 is a flowchart of an information transmission apparatus according to the sixth embodiment;

FIG. 21 is a flowchart of packet information processing of a management server according to the sixth embodiment; and

FIGS. 22A, 22B, 22C, and 22D are views showing examples of the database of the management server according to the sixth embodiment.

### DESCRIPTION OF EMBODIMENTS

Embodiments of the present invention will now be described with reference to the accompanying drawings. Note that the following embodiments are merely examples, and the technical scope of the present invention is not limited by the following embodiments.

### First Embodiment

The first embodiment of the present invention will be described below with reference to the accompanying drawings.

[Overall Conceptual View of System]

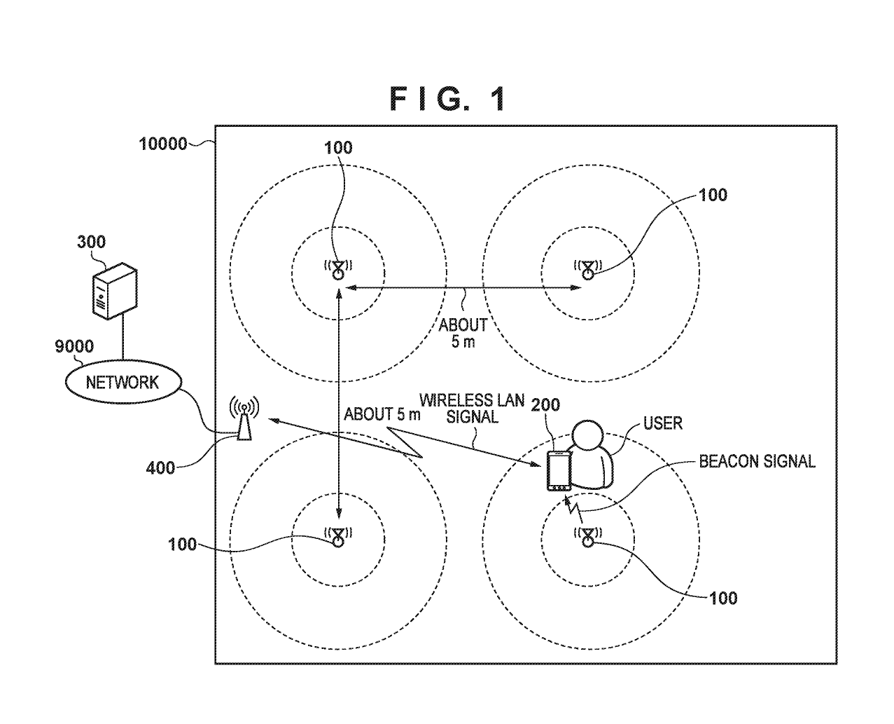

FIG. 1 shows the outline of a system including an information transmission apparatus 100, a mobile terminal 200, a management server 300, and a wireless access point 400 according to this embodiment.

An example of the information transmission apparatus 100 is a palm-size radio signal transmission beacon that can be placed as a user puts it on a shelf and driven by a battery. The information transmission apparatus 100 is assumed to always maintain an ON state unless the user directly turns the power off or the battery goes dead. At least one information transmission apparatus 100 is arranged in a location 10000. When the user comes close to the information transmission apparatus 100, the mobile terminal 200 held by the user can receive unique information according to the arranged information transmission apparatus 100. In terms of structure, the information transmission apparatus 100 may include, for example, an adhesive surface so that it can be not only put on a shelf or the like but also bonded to a wall surface, ceiling, undersurface of a desk, or the like. The information transmission apparatus 100 is assumed to incorporate, for example, a small battery such as an AA battery or a coin cell and continue to transmit a radio wave periodically (for example, once a second). Even if continuing to transmit a radio wave, power consumption is so low that the information transmission apparatus 100 can be driven for a predetermined period (for example, two years).

In this embodiment, Bluetooth® Low Energy will be exemplified as the radio wave transmitted by the information transmission apparatus 100. However, another wireless medium capable of operating with low power consumption, such as ZigBee®, may be used. In this embodiment, the coverage of the radio wave transmitted by the information transmission apparatus 100 is assumed to be about 15 m. When the radio field intensity (that is, the received signal level of the radio wave) is measured, how far the mobile terminal 200 is away from the information transmission apparatus 100 can be known. Generally, the longer the distance from the radio wave transmission source is, the lower the radio field intensity is, as is known. More specifically, close (1 m or less from the beacon), medium range (1 to 10 m from the beacon), long range (10 m or more from the beacon), and reception disable can be determined based on the measured radio field intensity. In this embodiment, the information transmission apparatus 100 will also be referred to as a beacon hereinafter. Note that the coverage is merely an example and is not limited to this.

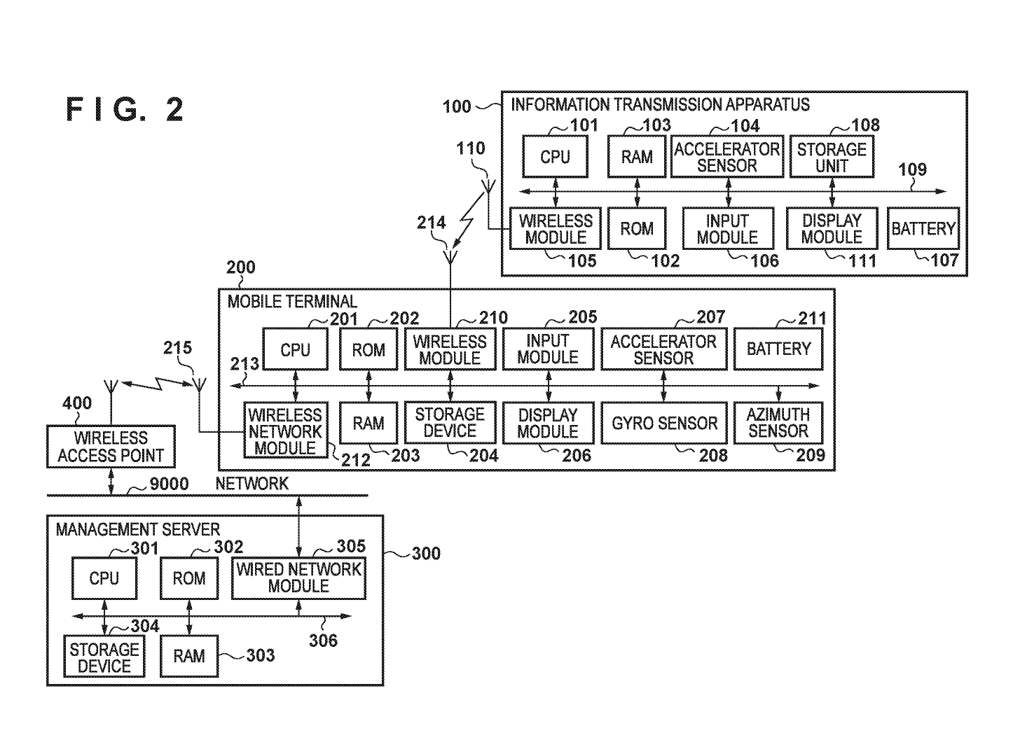

An example of the mobile terminal 200 is a smartphone or tablet terminal held by the user. The mobile terminal 200 incorporates a wireless module 210 configured to receives the radio wave transmitted by the information transmission apparatus 100, and a wireless network module 212 configured to exchange data with the wireless access point 400. The wireless module 210 and the wireless network module 212 will be described later in detail with reference to FIG. 2. The user who holds the mobile terminal 200 acquires useful information based on a received beacon signal of the information transmission apparatus 100 by a dedicated application that operates on the mobile terminal 200. Note that the mobile terminal 200 can be a glass type worn like glasses, a necklace type put on the user's neck, a wristwatch type put on a wrist, or a breast clip type that clips on a breast pocket.

An example of the management server 300 is a computer controlled by an OS (Operating System) such as Linux® or Windows®. The management server 300 includes a storage device 304 such as an HDD or SSD, and constructs a beacon location database 354 used to manage the location information of the information transmission apparatus 100. In response to a request from the mobile terminal 200, the management server 300 returns a processing result to the mobile terminal 200 via the wireless access point 400.

An example of the wireless access point 400 is a radio relay apparatus that exchanges data with the mobile terminal 200 by Wi-Fi® or the like. The wireless access point 400 is connected to a network 9000 via, for example, a wired LAN and can therefore exchange data with the management server 300 as well. Hence, the mobile terminal 200 and the management server 300 can perform data communication via the wireless access point 400. The network 9000 corresponds to, for example, the Internet.

An example of the location 10000 is a store or an office. The location 10000 can be any location if it is a space where the information transmission apparatus 100 and the wireless access point 400 can be placed, and the user can freely move. In this embodiment, an explanation will be made assuming that the user is present in a store where a plurality of information transmission apparatuses 100 are arranged. In the following description, the user is assumed to hold the mobile terminal 200, and the location of the user is regarded as the location of the mobile terminal 200.

[Hardware Arrangement]

FIG. 2 shows an example of the hardware arrangement of the information transmission apparatus 100, the mobile terminal 200, and the management server 300 shown in FIG. 1.

The information transmission apparatus 100 includes a CPU 101, a ROM 102, a RAM 103, an accelerator sensor 104, a wireless module 105, an input module 106, and a storage unit 108. These elements are connected by a system bus 109. The information transmission apparatus 100 broadcasts, by an antenna 110, a wireless packet signal generated by the wireless module 105 all around. A battery 107 supplies power to the units of the information transmission apparatus 100.

The CPU 101 is a unit configured to execute a control program 150. The ROM 102 is a nonvolatile memory and stores a boot loader program (not shown) and the control program 150. The RAM 103 is a volatile memory and stores, for example, information stored in the ROM 102 or information to be temporarily used because high-speed access is possible. When the information transmission apparatus 100 is powered on, the CPU 101 reads out and executes the boot loader program (not shown), extracts the control program 150 stored in the ROM 102, and stores it in the RAM 103. The CPU 101 executes the control program 150 stored in the RAM 103, thereby executing the functions of the information transmission apparatus 100.

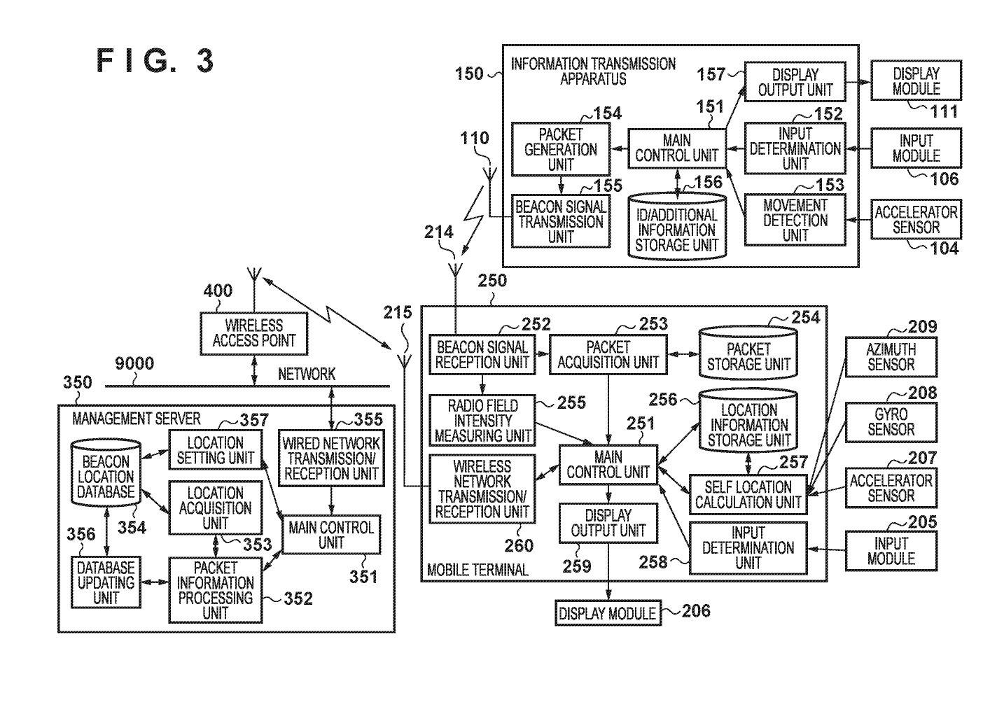

The accelerator sensor 104 can output accelerations along three axes, that is, the upward/downward axis (Y-axis), leftward/rightward axis (X-axis), and forward/backward axis (Z-axis) of the information transmission apparatus 100. Movement of the information transmission apparatus 100 can be detected based on the values of the output accelerations. The movement detection method of the information transmission apparatus 100 will be described later with reference to FIG. 3. The wireless module 105 encodes data into a wireless packet signal of Bluetooth® or the like and broadcasts the signal using the antenna 110. The input module 106 is used by the user to operate the information transmission apparatus 100. The input module 106 is formed from known UI components, for example, push switches. The user can power on/off the information transmission apparatus 100 or perform a reset operation for various settings using the input module 106.

The storage unit 108 is a storage medium such as an SRAM and is used as a place to store various kinds of setting data and processing data. In this embodiment, the antenna 110 can transmit/receive a 2.4-GHz RF (Radio Frequency) signal of Bluetooth® or Wi-Fi®. A display module 111 is formed from a display component such as an LED. The user can confirm the state of the information transmission apparatus 100 by light-emitting indication of the LED.

The mobile terminal 200 includes a CPU 201, a ROM 202, a RAM 203, a storage device 204, an input module 205, a display module 206, an accelerator sensor 207, a gyro sensor 208, an azimuth sensor 209, the wireless module 210, and the wireless network module 212. The elements included in the mobile terminal 200 are connected by a system bus 213. The mobile terminal 200 can receive, by an antenna 214, a wireless packet signal of Bluetooth® or the like broadcast from the information transmission apparatus 100. The mobile terminal 200 can also transmit/receive data to/from the management server 300 via the wireless access point 400 and the network 9000 by an antenna 215. A battery 211 supplies power to the units of the mobile terminal 200.

The CPU 201 is a unit configured to execute a control program 250 of various kinds of processing according to this embodiment. The ROM 202 is a nonvolatile memory and stores a boot loader program (not shown) and the control program 250. The RAM 203 is a volatile memory and stores, for example, information stored in the ROM 202 or information to be temporarily used because high-speed access is possible. When the mobile terminal 200 is powered on, the CPU 201 reads out and executes the boot loader program (not shown), extracts the control program 250 stored in the ROM 202, and stores it in the RAM 203. The CPU 201 executes the control program 250 stored in the RAM 203, thereby executing the functions of the mobile terminal 200.

The storage device 204 is a storage medium such as an SD card and is used as a place to store various kinds of setting data and received data. The storage device 204 is also used as a place to store data of results of processing executed by various kinds of programs. The input module 205 is used by the user to operate the mobile terminal 200. The input module 205 is formed from known UI components, for example, push switches and a touch panel. The user can power on/off the mobile terminal 200 or perform various setting operations and character input using the input module 205. A display module 206 is formed from known display components such as an LED and a liquid crystal panel, and can confirm the state of the mobile terminal 200 or notify the user of it by light emission of the LED or display of characters. Note that the input module 205 and the display module 206 need not be different parts and may be one part, for example, a touch-panel display.

The accelerator sensor 207 can output accelerations along three axes, that is, the X-, Y-, and Z-axes of the mobile terminal 200. The vertical direction of the mobile terminal 200 can be known based on the values of the output accelerations. The gyro sensor 208 can output the angular velocity of the mobile terminal 200. The gyro sensor 208 can calculate the relative angle from the reference direction by integrating the output angular velocities. An angle is generally expressed as a pitch, yaw, and roll. The tilt of the mobile terminal 200 can be represented as a rotation angle by the pitch/yaw/roll expression. Note that the gyro sensor 208 uses, for example, a semiconductor element using the Coriolis force, as is known. However, the present invention is not limited to this, and any method is usable.

The azimuth sensor 209 can measure the north, south, east, and west directions based on the earth magnetism, and converts the measured information into digital information. With the azimuth sensor 209, one of the north, south, east, and west directions in which the mobile terminal 200 faces on a physical space can be grasped. A user's walking action can be detected by processing the values output from the gyro sensor 208 and the accelerator sensor 207. More specifically, a walking action is detected using the periodicity and amplitude of the output value of each of the gyro sensor 208 and the accelerator sensor 207 at the time of user's waking. When the azimuth sensor 209 is combined with them, a relative location of the mobile terminal 200 from a given location can be calculated. The processing of detecting the user's walking action and relative location can be done using a conventional method, and a detailed description thereof will be omitted here.

The wireless module 210 converts a Bluetooth® wireless packet signal received by the antenna 214 into digital information and sends it to the control program 250. The wireless network module 212 is connected to the wireless access point 400 by Wi-Fi®, and thus transmits/receives data to/from devices such as various kinds of servers and personal computers connected via the network 9000. In this embodiment, the antennas 214 and 215 can transmit/receive a 2.4-GHz RF signal of Bluetooth® or Wi-Fi®.

The management server 300 includes a CPU 301, a ROM 302, a RAM 303, the storage device 304, and a wired network module 305. The elements are connected by a system bus 306. The management server 300 is connected to a commercial power supply, which supplies power to the units.

The CPU 301 is a unit configured to execute a control program 350 of various kinds of processing according to this embodiment. The ROM 302 is a nonvolatile memory and stores a boot loader program (not shown) and the control program 350. The RAM 303 is a volatile memory and stores, for example, information stored in the ROM 302 or information to be temporarily used because high-speed access is possible. When the management server 300 is powered on, the CPU 301 reads out and executes the boot loader program (not shown), extracts the control program 350 stored in the ROM 302, and stores it in the RAM 303. The CPU 301 executes the control program 350 stored in the RAM 303, thereby executing the functions of the management server 300.

The storage device 304 is a known mass storage medium such as an HDD or SSD and is used as a place to store various kinds of setting data, received data, and databases. The storage device 304 is also used as a place to store data of results of processing executed by the program. The wired network module 305 transmits/receives data to/from devices such as various kinds of servers and personal computers connected via the network 9000 and the mobile terminal 200 connected to the wireless access point 400.

[Software Configuration]

FIG. 3 shows an example of the software configuration of the information transmission apparatus 100, the mobile terminal 200, and the management server 300 shown in FIGS. 1 and 2.

The control program 150 included in the information transmission apparatus 100 is stored in the ROM 102 or the RAM 103 and executed by the CPU 101 to implement the present invention. A main control unit 151 mainly performs transmission control of a beacon signal based on determination of a movement detection unit 153 of the information transmission apparatus 100. A detailed control method will be described later.

An input determination unit 152 determines a user's input operation from the input module 106. The input determination unit 152 can determine, for example, one push (single push), long press for 3 sec or more, and the like of the push button of the input module 106. In this embodiment, more specifically, power on/off of the information transmission apparatus 100 can be switched by long press. In addition, a setting can be reset by single push. The movement detection unit 153 determines, based on the accelerator sensor value from the accelerator sensor 104, whether the information transmission apparatus 100 has moved. The movement detection is done by determining that the information transmission apparatus 100 has moved when each of the minimum and maximum values of the acceleration has exceeded a predetermined threshold within a predetermined time (for example, 10 sec). In addition, as a feature value of the accelerator sensor value, the frequency energy of each of the X-, Y-, and Z-axes within a predetermined time (for example, samples at 256 points of the acceleration) may be calculated. When a frequency energy other than DC components (stop) has exceeded a predetermined threshold, it may be determined that the information transmission apparatus 100 has moved. The root mean square value of the accelerator sensor values of each axis may be calculated, and a strength may be calculated as an acceleration. The movement may be determined by calculating the average of the acceleration values within a predetermined time. The movement detection by the accelerator sensor 104 is not limited to this, and any other method is usable if it can determine movement.

Based on an instruction from the main control unit 151, a packet generation unit 154 generates a signal packet to be transmitted from the information transmission apparatus 100. In this embodiment, a packet includes an “ID” that is identification information unique to the information transmission apparatus 100 and “additional information”. Here, the additional information corresponds to a movement detection flag representing movement of the information transmission apparatus 100. For example, if the information transmission apparatus 100 is not detecting movement, the signal packet to be transmitted has “ID: 01, movement detection flag: 0” as the contents. If the information transmission apparatus 100 is detecting movement, the signal packet to be transmitted has “ID: 01, movement detection flag: 1” as the contents. Details of additional information will be described later.

A beacon signal transmission unit 155 externally transmits, by the antenna 110, packet data generated by the packet generation unit 154 as an RF signal. In this embodiment, the RF signal is sent out to a range of about 15 m from the information transmission apparatus 100. However, the signal range is not limited to this because it changes depending on the external environment and the antenna shape.

An ID/additional information storage unit 156 stores the ID unique to the information transmission apparatus 100 and additional information such as the movement detection flag in the storage unit 108. An ID is assigned to each information transmission apparatus 100. By matching the ID included in the beacon signal, the reception side can identify the information transmission apparatus 100 as the transmission source of the beacon signal.

A display output unit 157 performs display output to the display module 111. By display output of the display output unit 157, the user can determine the power on/off state of the information transmission apparatus 100 and whether a setting is reset. More specifically, upon powering on, the LED of the display module 111 lights up for 10 sec and then lights out. Upon powering off, the LED blinks for 10 sec and then lights out. When a setting is reset, the LED blinks for 3 sec and then lights out.

The control program 250 included in the mobile terminal 200 is stored in the ROM 202 or the RAM 203 and executed by the CPU 201 to implement the present invention. A main control unit 251 mainly performs communication with the management server 300 based on a signal packet from a beacon and processing according to received location information. A detailed control method will be described later.

A beacon signal reception unit 252 receives an RF signal transmitted by the information transmission apparatus 100, converts it into a digital packet signal, and outputs the packet signal. A packet acquisition unit 253 acquires the packet of the beacon signal output from the beacon signal reception unit 252. More specifically, the packet acquisition unit 253 acquires an ID and additional information included in the packet and outputs them to the main control unit 251 as packet information. A packet storage unit 254 stores the packet information acquired by the packet acquisition unit 253.

A radio field intensity measuring unit 255 measures the received radio field intensity (or received signal intensity) of the RF signal received by the beacon signal reception unit 252 and outputs it to the main control unit 251. The received radio field intensity is generally represented by RSSI (Received Signal Strength Indicator) and expressed as a relative numerical value from 0 dBm that is the received radio field intensity at 1 mW. In this embodiment, the distance between the information transmission apparatus 100 and the mobile terminal 200 is measured by the numerical value of dBm. More specifically, a threshold is set in advance. If the radio field intensity of a received radio wave is −50 dBm or more, it is determined that the mobile terminal 200 is present within 1 m from the information transmission apparatus 100. The threshold can arbitrarily be set and changed in accordance with the antenna characteristic and the like.

A location information storage unit 256 stores the location of itself calculated by a self location calculation unit 257. The stored location information is used by the main control unit 251. The self location calculation unit 257 calculates the location of itself based on the outputs of the azimuth sensor 209, the gyro sensor 208, and the accelerator sensor 207 and the location information (absolute location) of the information transmission apparatus 100. The calculated location is stored in the location information storage unit 256 as needed. More specifically, the self location calculation unit 257 calculates the self location using the relative location by the sensors and the information (that is, absolute location) of the information transmission apparatus 100. The relative location is estimated as the user's relative location from a given point based on the direction and walking action of the user calculated from the sensor values. The absolute location is received from the management server 300 based on an ID transmitted by the information transmission apparatus 100 when the user has come close to the information transmission apparatus 100. If it is determined that the information transmission apparatus 100 is present within 1 m, the location of the device itself is obtained as the absolute location, and the relative location is reset to “0”.

A relative location estimation method using the sensors will be described. A user direction for the relative location estimation is measured by the azimuth sensor 209 from the earth magnetism. However, the reliability of the earth magnetism may be low indoors because of reinforcing bars of a building or the like. For this reason, if the reliability of the azimuth sensor 209 is determined to be low, vertical components and horizontal components are extracted from the output values of the accelerator sensor 207 and the gyro sensor 208, and a relative horizontal angle to the reference direction is calculated.

A user's walking action is detected by the gyro sensor 208 and the accelerator sensor 207. Whether the user is walking can be obtained from the magnitudes of the amplitudes of vertical components extracted from the accelerator sensor 207 and the gyro sensor 208. As is known, concerning a human walking action, periodical features appear in the vertical component and the horizontal component of each sensor. The number of steps can be measured by pattern matching between these features and the sensor output values.

An input determination unit 258 determines a user's input operation from the input module 205. The input determination unit 258 can determine, for example, one push (single push) or long press of the push button of the input module 205 or a character input operation to the touch panel. A display output unit 259 performs display output to the display module 206. A wireless network transmission/reception unit 260 transmits/receives data to/from a server or personal computer connected to the network 9000 via the wireless access point 400.

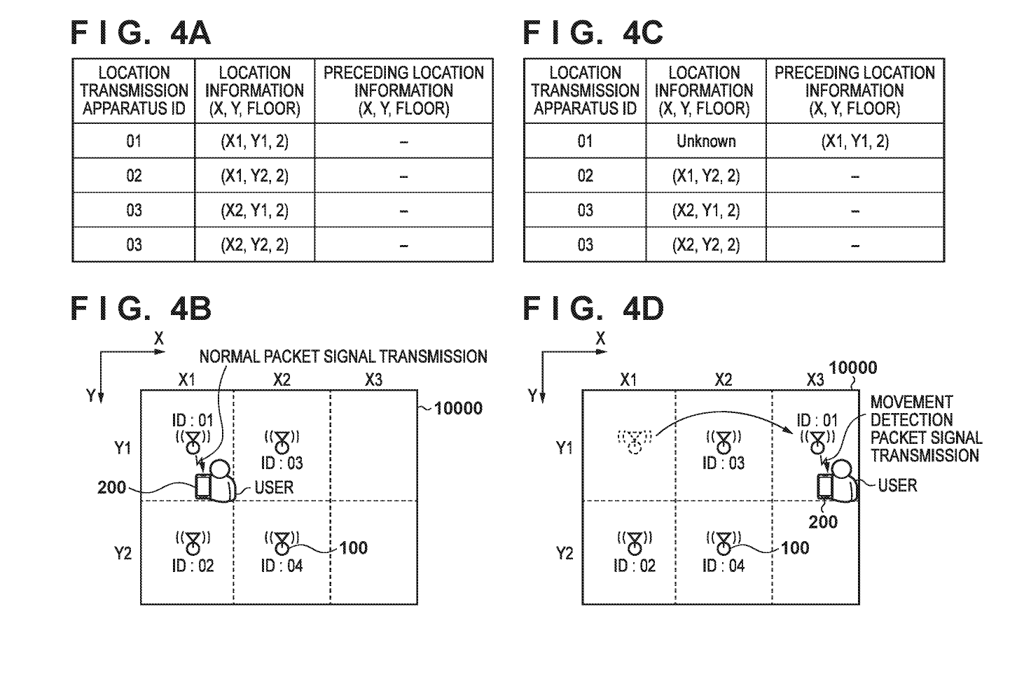

The control program 350 included in the management server 300 is stored in the ROM 302 or the RAM 303 and executed by the CPU 301 to implement the present invention. A main control unit 351 mainly performs processing according to a request from the mobile terminal 200 and management of the beacon location database. A detailed control method will be described later. A packet information processing unit 352 performs processing according to packet information transmitted from the information transmission apparatus 100. A location acquisition unit 353 acquires location information from the beacon location database 354 in response to a request of the packet information processing unit 352. The beacon location database 354 holds the ID of each information transmission apparatus 100 (that is, beacon) and corresponding location information as a database. A detailed example of the database will be described later with reference to FIGS. 4A to 4D.

A wired network transmission/reception unit 355 transmits/receives data to/from the mobile terminal 200 via the network 9000. A database updating unit 356 updates the information of the beacon location database 354 in response to a request of the packet information processing unit 352. More specifically, the database updating unit 356 changes the location information of a beacon or other parameters on the database.

A location setting unit 357 sets the location information parameter of a beacon. More specifically, the location setting unit 357 sets location information parameter in the beacon location database 354 in accordance with an instruction from a personal computer (not shown) operated by a user connected to the network 9000. The parameters of the database in which the ID of each information transmission apparatus 100 is linked to location information, as shown in FIG. 4A, can be set to arbitrary values by the location setting unit 357. Location setting by the location setting unit 357 may be executed not by the personal computer (not shown) but by an application of the mobile terminal 200.

The procedure of setting location information of the information transmission apparatus 100 by the location setting unit 357 will be described. Location setting of the information transmission apparatus 100 can be performed before it is placed for the first time or after the placement via the mobile terminal 200. If setting the location before the placement, the ID and location information are set in the beacon location database 354, and after that, the user places the information transmission apparatus 100 at the location of the corresponding ID. If performing location setting via the mobile terminal 200, a beacon is designated based on the radio field intensity, and the location of the beacon may be set at a designated location on a map. Beacon location setting based on the radio field intensity is performed using a conventional method, and a detailed description thereof will be omitted here.

[Data Structure]

The structure of the beacon location database 354 of the management server 300 handled in this embodiment will be described below with reference to FIGS. 4A to 4D. In addition, the relationship between the user (mobile terminal 200) and the information transmission apparatus 100 when the database is updated will be described. Note that detailed database updating processing will be described later together with the flowcharts of each embodiment.

FIG. 4A shows the beacon location database 354 in a state in which the information transmission apparatus 100 is initially placed. The first column stores the IDs of the information transmission apparatuses 100. The second column stores location information (X, Y, floor) of the information transmission apparatuses 100. The location information is represented by three parameters. The first parameter X and the second parameter Y correspond to a section on the horizontal plane of a building shown in FIG. 4B. The third parameter “floor” represents a floor of the building.

FIG. 4B shows the arrangement image of the information transmission apparatuses 100 when the beacon location database 354 has the state shown in FIG. 4A. At this time, each of the information transmission apparatuses 100 having IDs “01” to “04” is transmitting a normal packet signal. Here, the location 10000 is divided into six sections along the ordinate and the abscissa. At the time of initial placement, the beacon location database 354 is set as shown in FIG. 4A such that each ID representing a beacon (information transmission apparatuses 100) and the section where the beacon is arranged are associated with each other.

FIG. 4C shows the beacon location database 354 after the information transmission apparatus 100 of the ID “01” is moved. FIG. 4D shows the arrangement image of the information transmission apparatuses 100 when the beacon location database 354 has the state shown in FIG. 4C. At this time, each of the information transmission apparatuses 100 having IDs “02” to “04” is transmitting a normal packet signal. The information transmission apparatus 100 of the ID “01” moves from the section (X1, Y1, 2) to (X3, Y1, 2), as indicated.

[Processing Procedure]

### (Processing of Information Transmission Apparatus)

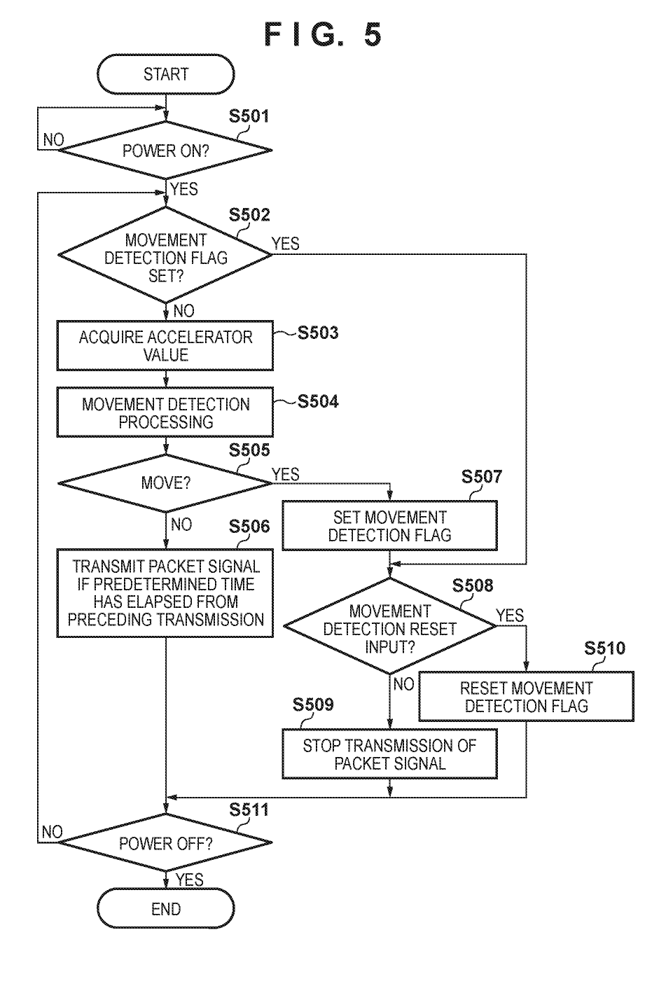

FIG. 5 is a flowchart of processing of causing the information transmission apparatus 100 according to the first embodiment to control a beacon signal based on the accelerator sensor 104. Steps S501 to S511 in the flowchart of FIG. 5 are implemented by causing the CPU 101 of the information transmission apparatus 100 to execute a program stored in the ROM 102.

In step S501, the information transmission apparatus 100 determines whether it is powered on. Power on/off can be switched by long press of the push button of the input module 106. If the information transmission apparatus is powered on (YES in step S501), the process advances to step S502. Otherwise (NO in step S501), the processing waits until power on.

In step S502, the information transmission apparatus 100 determines whether the movement detection flag is set. More specifically, if the movement detection flag stored in the ID/additional information storage unit 156 is “1” that represents that the information transmission apparatus 100 has moved (YES in step S502), the process advances to step S508. If the movement detection flag is “0” that represents that the information transmission apparatus 100 has not moved (NO in step S502), the process advances to step S503.

In step S503, the information transmission apparatus 100 acquires the value of the accelerator sensor 104. In step S504, the information transmission apparatus 100 performs movement detection processing based on the acquired value of the accelerator sensor 104. In step S505, the information transmission apparatus 100 determines based on the result of step S504 whether the information transmission apparatus 100 has moved. Upon determining that the information transmission apparatus 100 has moved (YES in step S505), the process advances to step S507. Otherwise (NO in step S505), the process advances to step S506.

In step S506, if a predetermined time has elapsed from preceding signal transmission, the information transmission apparatus 100 transmits a packet signal. More specifically, if a time of 1 sec or more has elapsed from preceding signal transmission in a case where the ID of the information transmission apparatus 100 is “01”, the information transmission apparatus 100 transmits a packet “ID: 01” as an RF signal. However, the predetermined time “1 sec” is merely an example here, and the time can be set to any other arbitrary value.

In step S507, the information transmission apparatus 100 sets the movement detection flag in the ID/additional information storage unit 156. More specifically, the ID/additional information storage unit 156 stores the movement detection flag as “1” that represents that the information transmission apparatus 100 has moved.

In step S508, the information transmission apparatus 100 determines whether a movement detection reset is input by the user. More specifically, single push by the input determination unit 152 is determined as a movement detection reset. If a movement detection reset is input (YES in step S508), the process advances to step S510. Otherwise (NO in step S508), the process advances to step S509. In step S509, the information transmission apparatus 100 steps transmitting the packet signal. That is, the information transmission apparatus 100 does not transmit a packet signal while the movement detection flag is set. In step S510, the information transmission apparatus 100 resets the movement detection flag in the ID/additional information storage unit 156. More specifically, the information transmission apparatus 100 stores the movement detection flag in the ID/additional information storage unit 156 as “0” that represents that the information transmission apparatus 100 has not moved.

In step S511, the information transmission apparatus 100 determines whether it is powered off. When the push button of the input module 106 is pressed long in the power-on state, the information transmission apparatus 100 transits to the power-off state. If the information transmission apparatus 100 is powered off (YES in step S511), the processing ends. Otherwise (NO in step S511), the process returns to step S502.

(Processing of Mobile Terminal and Management Server)

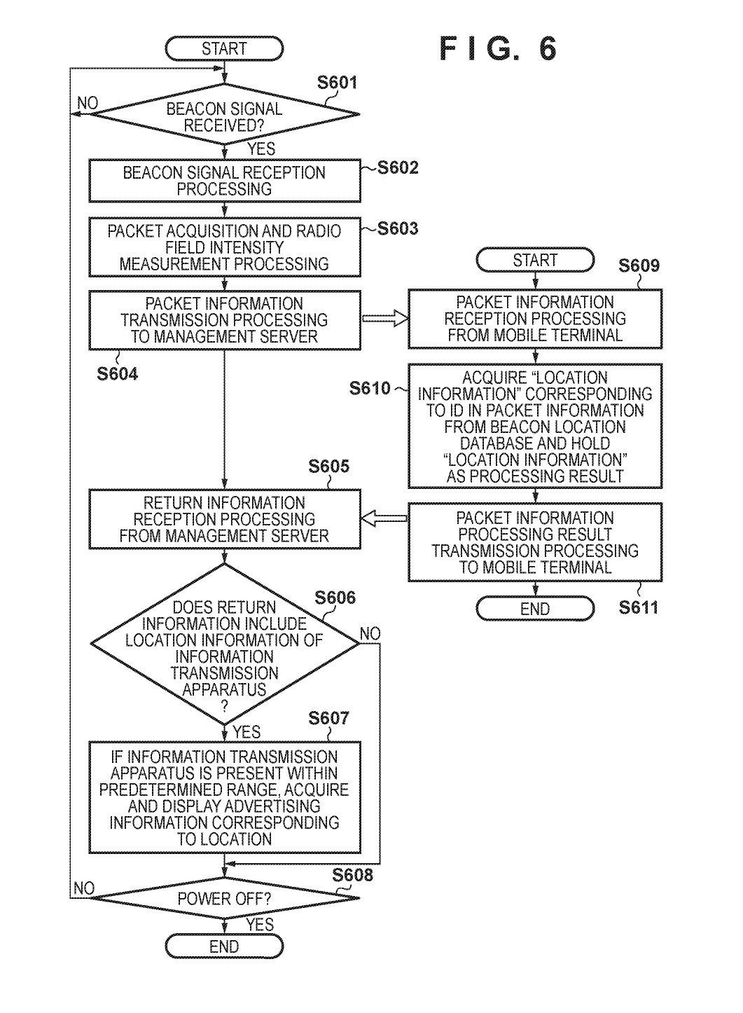

Processing of location information based on a beacon signal will be described with reference to FIGS. 4A to 4D, 6, and 7A to 7C. FIG. 6 is a flowchart of beacon signal processing of the mobile terminal 200 and the management server 300 upon receiving a beacon signal. FIGS. 4A to 4D are views showing the beacon location database 354 of the management server 300 and the positional relationship between the user and the information transmission apparatuses 100 in the location 10000. Steps S601 to S608 of FIG. 6 are implemented by causing the CPU 201 of the mobile terminal 200 to execute a program stored in the ROM 202. In addition, steps S609 to S611 are implemented by causing the CPU 301 of the management server 300 to execute a program stored in the ROM 302.

In step S601, the mobile terminal 200 determines whether a beacon signal transmitted from the information transmission apparatus 100 is received. More specifically, when the user who holds the mobile terminal 200 enters the transmission range (15 m in this embodiment) of the information transmission apparatus 100 that is transmitting a beacon signal and receives the beacon signal, it is determined that a beacon signal is received. Upon receiving a beacon signal (YES in step S601), the process advances to step S602. Otherwise (NO in step S601), the processing waits until reception.

In step S602, the mobile terminal 200 performs beacon signal reception processing. More specifically, the beacon signal reception unit 252 converts an RF signal into a digital signal and outputs it, as described above.

In step S603, the mobile terminal 200 performs packet acquisition and radio field intensity measurement processing. More specifically, those processes are performed by the packet acquisition unit 253 and the radio field intensity measuring unit 255, as described above.

In step S604, the mobile terminal 200 transmits packet information to the management server 300 via the wireless network transmission/reception unit.

In step S605, the mobile terminal 200 receives return information from the management server 300 via the wireless network transmission/reception unit 260 as a response to the packet information transmitted in step S604. In step S606, the mobile terminal 200 determines whether the return information includes the location information of the information transmission apparatus 100. For example, if the return information includes a value as location information such as “ID: 01, location information: (X1, Y1, 2)”, it is determined as location information. If the return information includes location information (YES in step S606), the process advances to step S607. Otherwise (NO in step S606), the process advances to step S608.

In step S607, if the information transmission apparatus 100 is present within a predetermined range, the mobile terminal 200 acquires advertising information corresponding to the location information in step S606 from an advertising server (not shown) and displays the advertising information on the display module 206. More specifically, upon determining, based on the received radio field intensity measured in step S603, that the beacon is present within 1 m, advertising information is displayed on the display module 206. The advertising information corresponds to a PDF, text information, image data such as JPEG image data, or a URL that is the address of an advertising page to be displayed. However, the advertising information is not limited to a format of information if it is information useful for a customer, such as the PR information of an article or a coupon of a store. Note that the advertising server manages advertising information corresponding to location information in an advertising database (not shown).

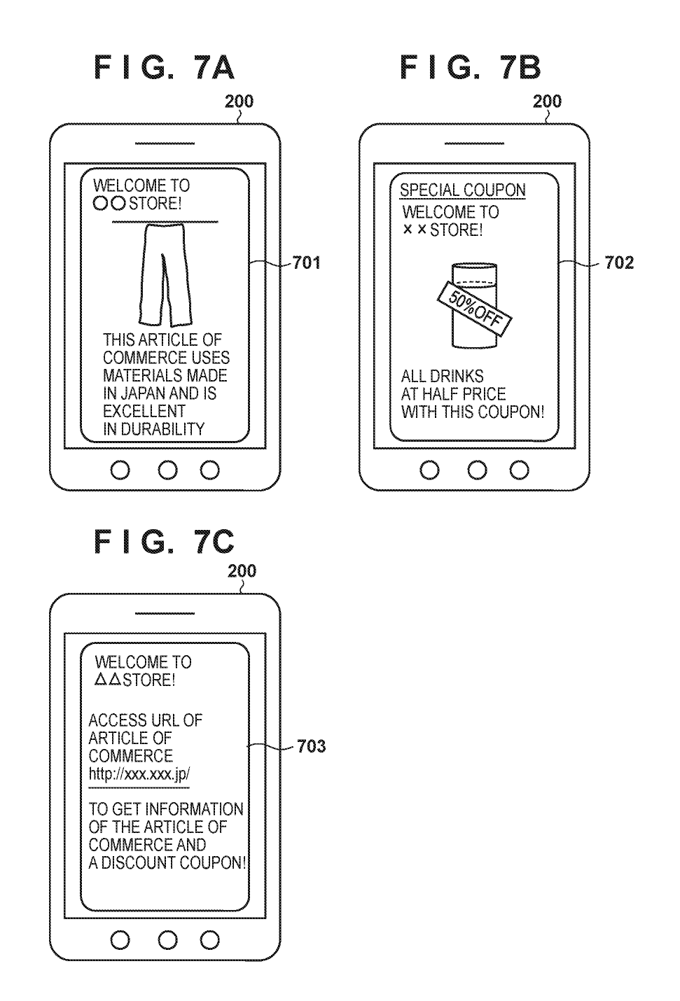

FIGS. 7A to 7C show images of advertising information. FIG. 7A shows detailed information of a certain article of commerce (trousers) displayed when the user has come close to the information transmission apparatus 100 placed near the article of commerce (trousers). FIG. 7B shows the coupon image of a drink displayed when the user has come close to the information transmission apparatus 100 placed in the entrance of a certain store. FIG. 7C shows the image of a URL displayed when the user has come close to an article of commerce in a certain store. The user can obtain the coupon and the information of the article of commerce by tapping the URL displayed on the touch panel that is the input module 205. Note that in this embodiment, advertising information concerning an article of commerce or the like has been described as information to be displayed. However, the present invention is not limited to this, and the user may be allowed to acquire and display arbitrary information. An advertising server has been described as a server that provides advertising information. However, the present invention is not limited to this and, for example, the management server 300 may provide corresponding information.

In step S608, the mobile terminal 200 determines whether it is powered off. When the push button of the input module 205 is pressed long in the power-on state, the mobile terminal 200 transits to the power-off state. If the mobile terminal 200 is powered off (YES in step S608), the processing ends. Otherwise (NO in step S608), the process returns to step S601.

In step S609, the management server 300 receives the packet information from the mobile terminal 200 via the wired network transmission/reception unit 355. The main control unit 351 sends the received packet information to the packet information processing unit 352. In step S610, the management server 300 acquires location information corresponding to the ID of the packet information from the beacon location database 354, and holds the location information as an information processing result to be received by the mobile terminal 200. Note that the location information in the beacon location database 354 is held as shown in FIG. 4A. When the user has come close to the information transmission apparatus 100 of the ID “01”, as shown in FIG. 4B, location information received by the user is (X1, Y1, 2). In step S611, the management server 300 causes the wired network transmission/reception unit 355 to transmit the packet information processing result to the mobile terminal 200. Note that the packet information processing result is received by the mobile terminal 200 as return information (step S605).

In the first embodiment, the flowchart of the information transmission apparatus 100 and the flowchart of the mobile terminal 200 and the management server 300 are illustrated, and the system operation when the information transmission apparatus 100 has been moved from its original location has been described. When moved, the information transmission apparatus 100 stops transmitting the packet signal. This prevents the mobile terminal 200 from receiving wrong information.

### Second Embodiment

The second embodiment of the present invention will be described below. In the first embodiment, an example has been described in which when the information transmission apparatus 100 detects movement, transmission of packet information is stopped. In the second embodiment, an example will be described in which when an information transmission apparatus 100 detects movement, a movement detection packet including it is transmitted, thereby updating the database of a management server 300. The difference from the first embodiment will mainly be described.

[Processing Procedure]

### (Processing of Information Transmission Apparatus)

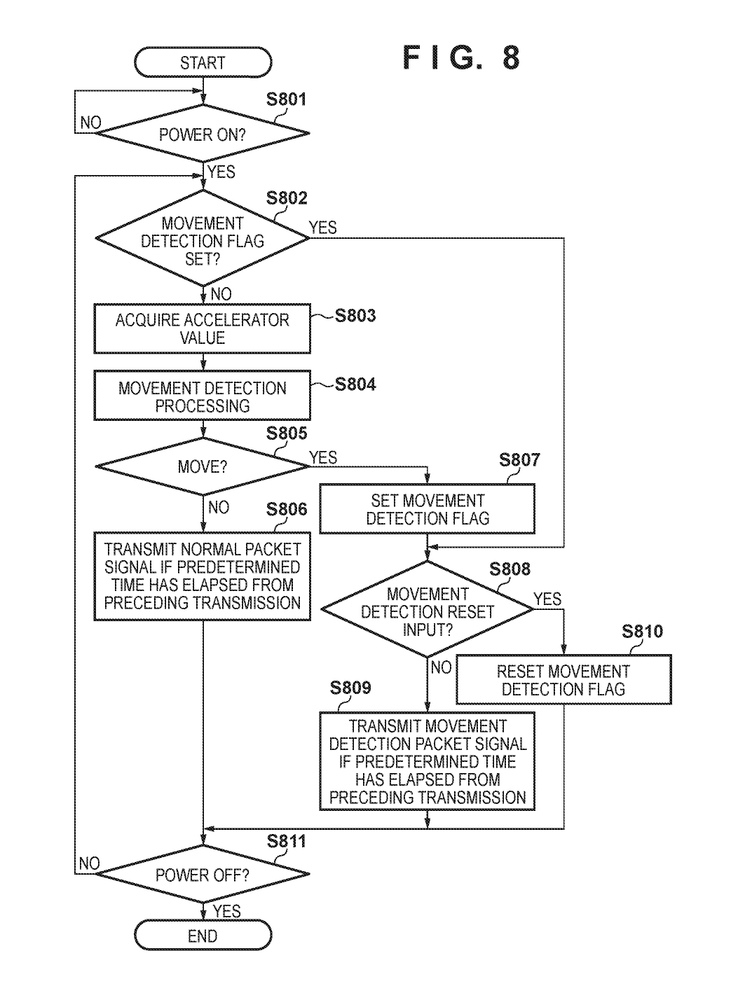

FIG. 8 is a flowchart of processing of causing the information transmission apparatus 100 to control a beacon signal based on an accelerator sensor 104. Steps S801 to S811 of FIG. 8 are implemented by causing a CPU 101 of the information transmission apparatus 100 to execute a program stored in a ROM 102. Steps S801 to S808, S810, and S811 are the same as steps S501 to S508, S510, and S511 of FIG. 5 described in the first embodiment, and a description thereof will be omitted. This embodiment is different from the first embodiment in that when the information transmission apparatus 100 detects movement, a signal including information representing it is transmitted at a predetermined interval.

In step S809, if a predetermined time has elapsed from preceding signal transmission, the information transmission apparatus 100 transmits a movement detection packet signal. More specifically, if a time of 1 sec or more has elapsed from preceding signal transmission in a case where the ID of the information transmission apparatus 100 is “01, the information transmission apparatus 100 transmits, as an RF signal, a movement detection packet “ID: 01, movement detection flag: 1” representing that movement is detected. That is, the movement detection flag representing movement is added to the ID serving as identification information and transmitted. Note that the predetermined time “1 sec” is merely an example here, and the time can be set to an arbitrary value.

(Processing of Mobile Terminal and Management Server)

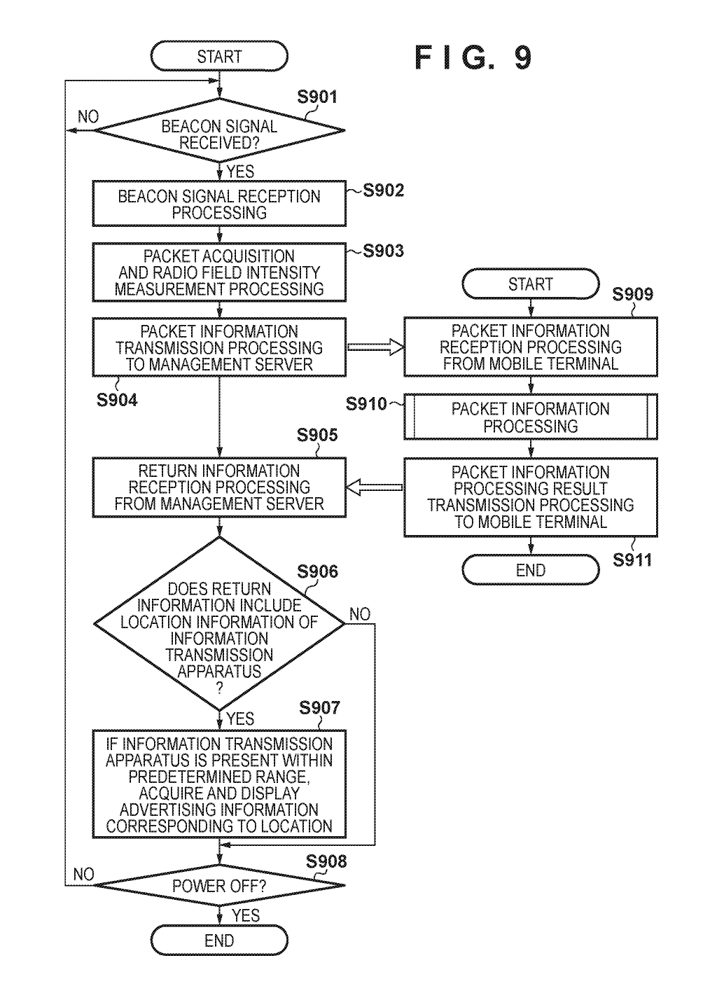

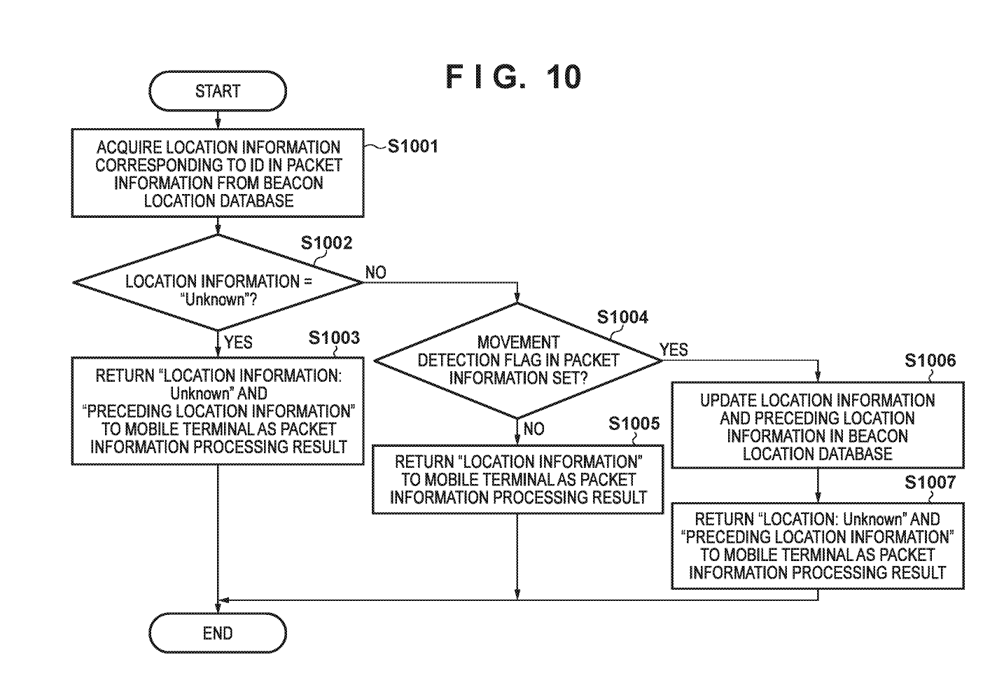

Processing of location information based on a beacon signal will be described with reference to FIGS. 4A to 4D, 9, and 10. FIG. 9 is a flowchart of beacon signal processing of a mobile terminal 200 and a management server 300 upon receiving a beacon signal. FIG. 10 is a flowchart of packet information processing of the management server 300.

Steps S901 to S908 of FIG. 9 are implemented by causing a CPU 201 of the mobile terminal 200 to execute a program stored in a ROM 202. In addition, steps S909 to S911 are implemented by causing a CPU 301 of the management server 300 to execute a program stored in a ROM 302. Steps S901 to S909, and S911 are the same as steps S601 to S609 and S611 of FIG. 6 described in the first embodiment, and a description thereof will be omitted here. This embodiment is different from the first embodiment in that when the management server 300 receives a movement detection packet, the beacon location information of a corresponding ID is changed to “Unknown”.

In step S910, the management server 300 performs packet information processing. Details of the processing of this step will be described with reference to FIG. 10. Steps S1001 to S1007 in the flowchart of FIG. 10 are implemented by causing the CPU 301 of the management server 300 to execute a program stored in the ROM 302.

In step S1001, the management server 300 acquires location information corresponding to the ID included in the packet information from a beacon location database 354. For example, if the beacon location database 354 has the state shown in FIG. 4A, and the ID is “01”, location information “(X1, Y1, 2)” is acquired from the location information string in FIG. 4A. If the beacon location database 354 has the state shown in FIG. 4C, and the ID is “01”, location information “Unknown” is acquired from the location information string in FIG. 4C.

In step S1002, the management server 300 determines whether the acquired location information is “Unknown”. For example, if the beacon location database 354 has the state shown in FIG. 4C, and the ID is “01”, the location information is determined as “Unknown”. If the location information is “Unknown” (YES in step S1002), the process advances to step S1003. Otherwise (NO in step S1002), the process advances to step S1004.

In step S1003, the management server 300 obtains the location information “Unknown” as the packet information processing result and returns it to the mobile terminal 200 together with preceding location information. For example, if the acquired location information is that of the first row of FIG. 4C, the management server 300 returns “location information: Unknown, preceding location information: (X1, Y1, 2)” as the processing result. In this case, the user is present close to the information transmission apparatus 100 whose ID after movement detection is “01”, as shown in FIG. 4D.

In step S1004, the management server 300 determines whether the movement detection flag of the packet information is set. For example, if the packet information is “ID: 01, movement detection flag: 1”, it is detected that the movement detection flag is set. Upon determining that the movement detection flag is set (YES in step S1004), the process advances to step S1006. Otherwise (NO in step S1004), the process advances to step S1005.

In step S1005, the management server 300 returns the location information to the mobile terminal 200 as the packet information processing result. For example, if the location information acquired from the beacon location database 354 is that of the first row of FIG. 4A, the management server 300 returns “location information: Unknown, preceding location information: (X1, Y1, 2)” as the processing result. In this case, the user is present close to the information transmission apparatus 100 whose ID before movement detection is “01”, as shown in FIG. 4B.

In step S1006, the management server 300 updates the location information and the preceding location information in the beacon location database 354. More specifically, if the location information before updating is that of the first row of FIG. 4A, the management server 300 updates the location information to “Unknown”, as in the first row of FIG. 4C, and the preceding location information to “(X1, Y1, 2)”, that is the location information shown in FIG. 4A by the updating processing. In step S1007, the management server 300 returns “location information: Unknown” and “preceding location information” to the mobile terminal 200 as the packet information processing result. For example, if the acquired location information is that of the first row of FIG. 4C, the management server 300 returns “location information: Unknown, preceding location information: (X1, Y1, 2)” as the processing result. In this case, the user is present close to the information transmission apparatus 100 whose ID after movement detection is “01”, as shown in FIG. 4D.

In the second embodiment, the flowchart of the information transmission apparatus 100 and the flowchart of the mobile terminal 200 and the management server 300 are illustrated, and the system operation when the information transmission apparatus 100 has been moved from its original location has been described. The information transmission apparatus 100 itself thus transmits information representing that it has been moved, and rewrites the beacon location database 354 to appropriate information via the mobile terminal 200. This can prevent the mobile terminal 200 from receiving wrong information.

### Third Embodiment

The third embodiment of the present invention will be described below. In the third embodiment, an example will be described in which when the user is prompted to update the “Unknown” location information of an information transmission apparatus 100 to correct information. Note that in a store or the like, both customers and clerks can hold mobile terminals 200 and receive location information. However, only the clerks may be prompted to update the location information. For example, a distinction between customers and clerks is made by login information of an application on the mobile terminals 200, and only the clerks may be prompted to do updating. Alternatively, only the clerks may separately install an application used to update a location. The difference from the second embodiment will mainly be described below.

[Processing Procedure]

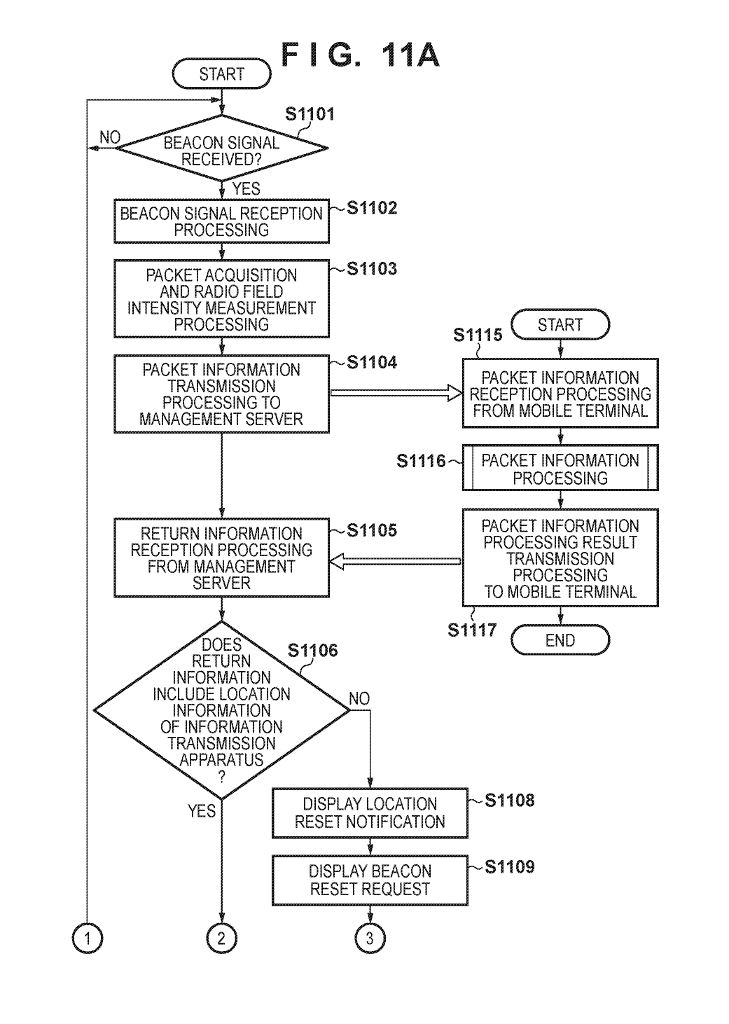

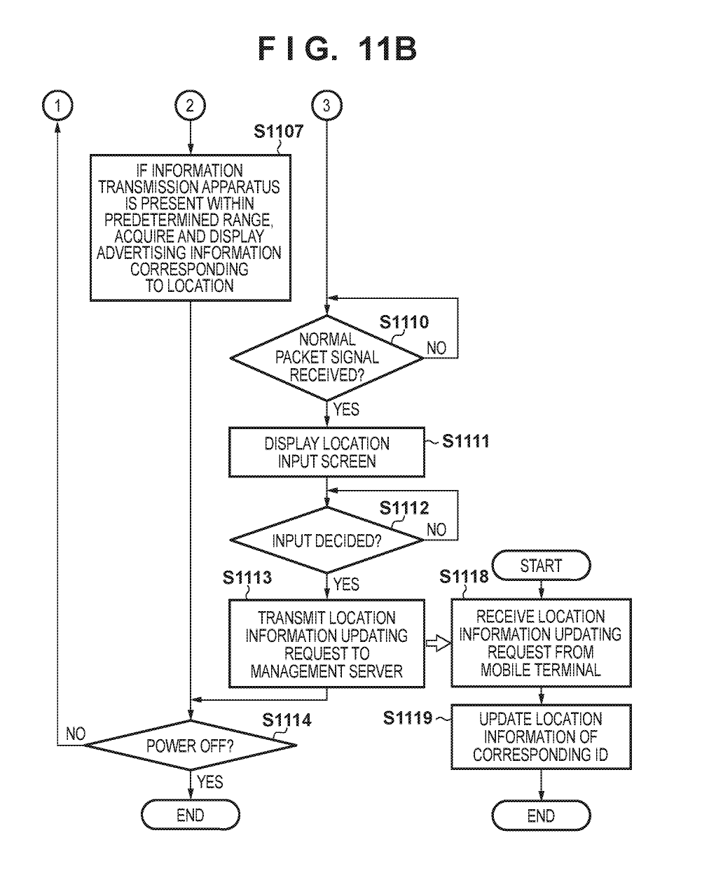

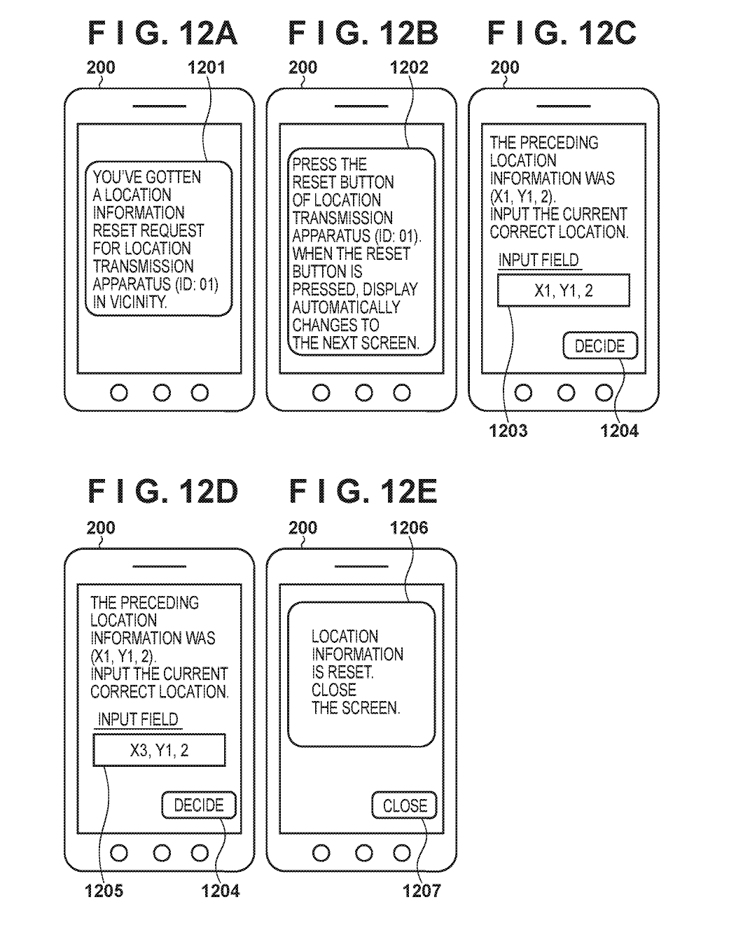

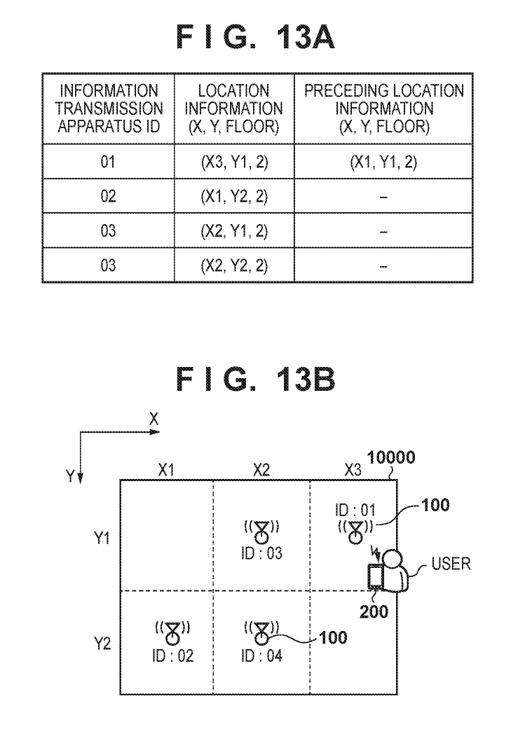

Processing of updating location information to correct location information according to this embodiment will be described with reference to FIGS. 11 to 13B. FIGS. 11A and 11B are flowcharts of beacon signal processing of the mobile terminal 200 and a management server 300 upon receiving a beacon signal. FIGS. 12A to 12E show a display example of the screen of the user's mobile terminal 200 that has received a location information updating notification. FIGS. 13A and 13B show examples of a beacon location database 354 of the management server 300 and the arrangement image of the information transmission apparatuses 100.

Steps S1101 to S1114 in the flowcharts of FIGS. 11A and 11B are implemented by causing a CPU 201 of the mobile terminal 200 to execute a program stored in a ROM 202. Steps S1115 to S1119 are implemented by causing a CPU 301 of the management server 300 to execute a program stored in a ROM 302. Steps S1101 to S1107, and S1114 to S1117 are the same as steps S901 to S911 of FIG. 9 described in the second embodiment, and a description thereof will be omitted here. This embodiment is different from the second embodiment in that the user is prompted to reset the location of the information transmission apparatus 100, and the information in the management server 300 is updated based on the reset information. According to this embodiment, it is possible to prompt the user to maintain the location information of the information transmission apparatus 100 in an appropriate state and update the location information in the management server 300 to correct information.

In step S1108, the mobile terminal 200 displays a location reset notification on a display module 206. More specifically, a display 1201 that makes a notification to cause the user to reset the location of the information transmission apparatus pops up, as shown in FIG. 12A. Note that at this time, the notification may be made together with a vibration by the vibration function of the mobile terminal 200. The user receives the notification when coming close to the information transmission apparatus 100 whose location has changed due to movement, as shown in FIG. 13B. The range where the notification is receivable is the range where the radio wave from the information transmission apparatus 100 is receivable. The notification may be made only when the user has come closer to the information transmission apparatus 100 within the range where the radio wave is receivable. When the user selects a notification list (not shown) by a tapping operation or the like, the screen transits to that shown in FIG. 12B. Note that a description will be made assuming that a beacon location database 354 of the management server 300 has the state shown in FIG. 4C at this time.

In step S1109, the mobile terminal 200 displays a screen of a reset request of the movement detection flag of the information transmission apparatus 100. More specifically, a display 1202 that prompts the user to do reset of a corresponding information transmission apparatus is output, as shown in FIG. 12B. At this time, if reset is performed for the information transmission apparatus 100 that transmits the movement detection packet signal, the information transmission apparatus 100 starts transmitting a normal packet signal in place of the movement detection packet signal. Hence, the mobile terminal 200 compares the received normal packet signal with the signal received so far, thereby detecting pressing of the reset button by the user and automatically transiting to the next state shown in FIG. 12C. Note that the information transmission apparatus 100 that is transmitting the movement detection packet preferably, for example, blinks the LED such that the user can immediately find the moved information transmission apparatus 100.

In step S1110, the mobile terminal 200 determines whether the normal packet signal is received from the information transmission apparatus 100 of the ID that has transmitted the movement detection packet signal till then. If the normal packet signal is received (YES in step S1110), the process advances to step S1111. Otherwise (NO in step S1110), the processing waits until reception.

In step S1111, the mobile terminal 200 displays a location input screen used to set a correct location for the information transmission apparatus 100. More specifically, the screen shown in FIG. 12C is displayed. At this time, location information (FIG. 4C) before the movement may be displayed in an input field 1203 for the user. FIG. 12D shows an example of the screen when user input is performed. The user can determine the input by tapping a decision icon 1204. When the input is determined, the screen transits to a screen 1206 shown in FIG. 12E, and the input operation by the user ends upon tapping a close icon 1207. Note that the characters in the input field may be determined, and if invalid characters are input, the decision icon may be grayed out to prohibit the user from pressing.

In step S1112, the mobile terminal 200 determines whether the input of the location information is decided by the user. More specifically, when the decision icon 1204 shown in FIG. 12D is tapped, it is determined that the input of the location information is decided. If the input is decided (YES in step S1112), the process advances to step S1113. Otherwise (NO in step S1112), the processing waits until decision. In step S1113, the mobile terminal 200 requests the management server 300 to set location information input to an input field 1205 shown in FIG. 12D as new location information. For example, the mobile terminal 200 transmits “ID: 01, reset location information: (X3, Y1, 2)” as the location information updating request.

In step S1118, the management server 300 receives the location information updating request transmitted from the mobile terminal 200 in step S1113. In step S1119, based on the ID included in the received location information updating request, the management server 300 updates the location information of the ID to the reset location information. More specifically, the location information “Unknown” of the ID “01”, which originally has the state shown in FIG. 4C, is updated to the location information “(X3, Y1, 2)”, as shown in FIG. 13A, based on the user input.

In the third embodiment, an example has been described in which the user is prompted to update the location information (“Unknown”) of the information transmission apparatus 100 to correct information and input the location information, thereby updating the database to correct information. Since this allows even a user other than a special user such as an administrator to appropriately set the location information of the moved information transmission apparatus, the labor in management can be reduced. In addition, since location reset is notified at the timing at which the user has come close to the moved information transmission apparatus, the user can easily find the moved information transmission apparatus.

### Fourth Embodiment

The fourth embodiment of the present invention will be described. In the fourth embodiment, an example will be described in which the location information of an information transmission apparatus 100 after movement is automatically estimated. The difference from the second embodiment will mainly be described below.

[Processing Procedure]

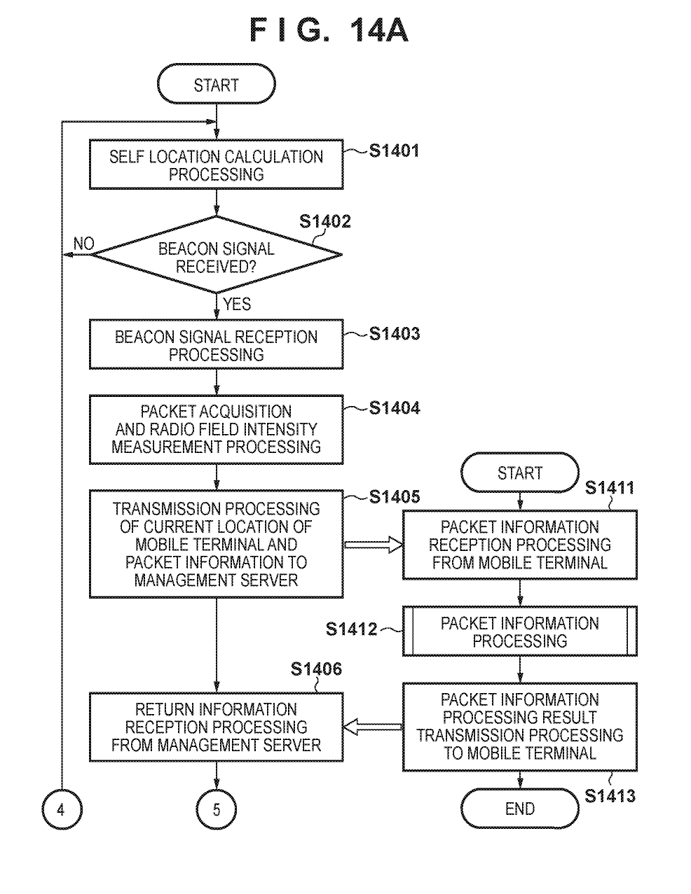

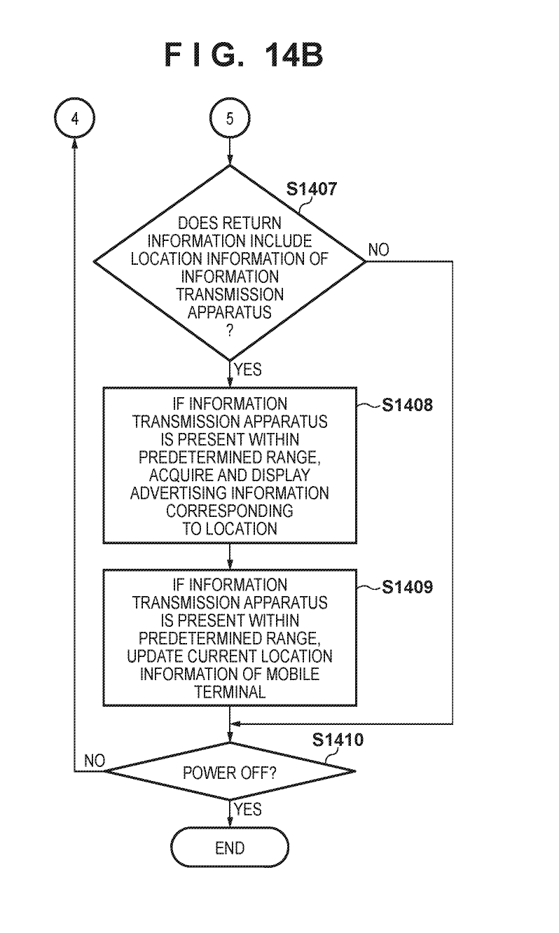

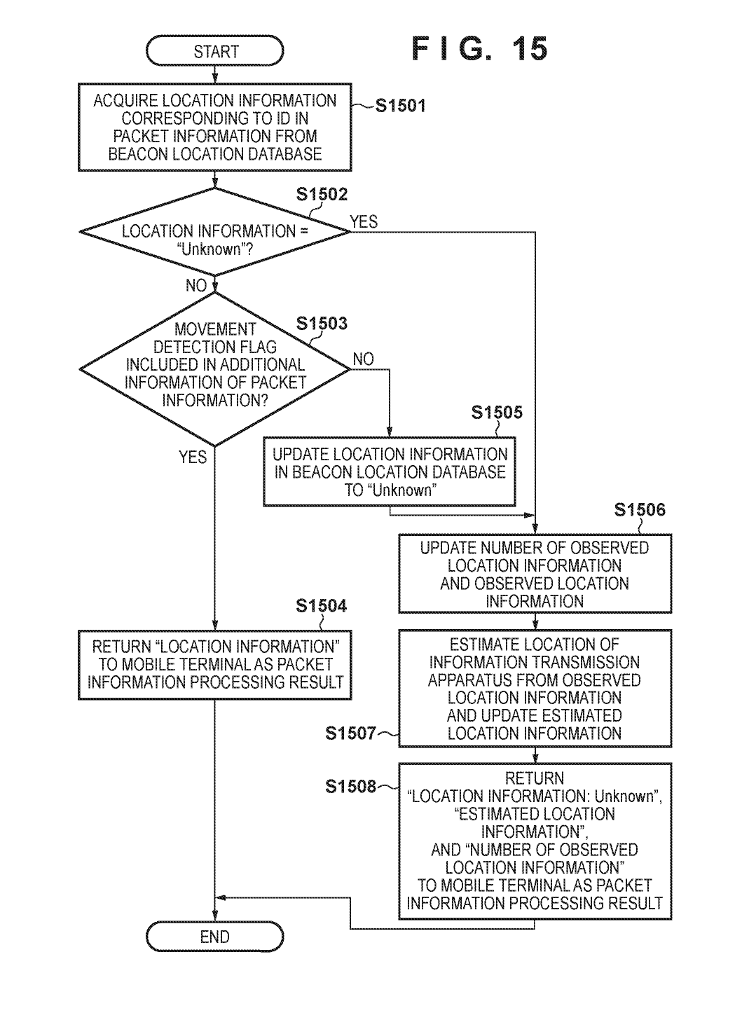

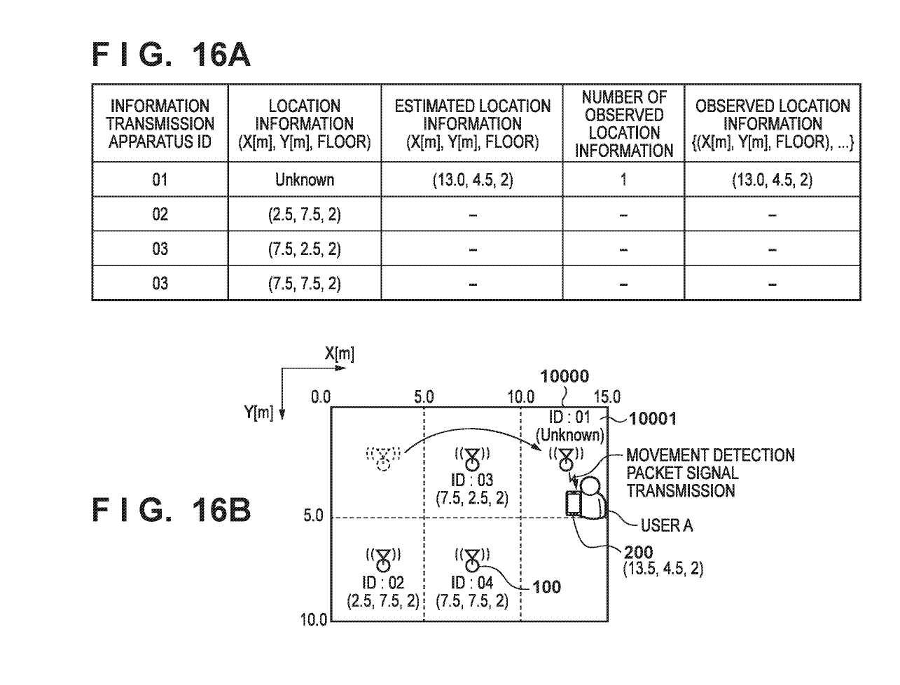

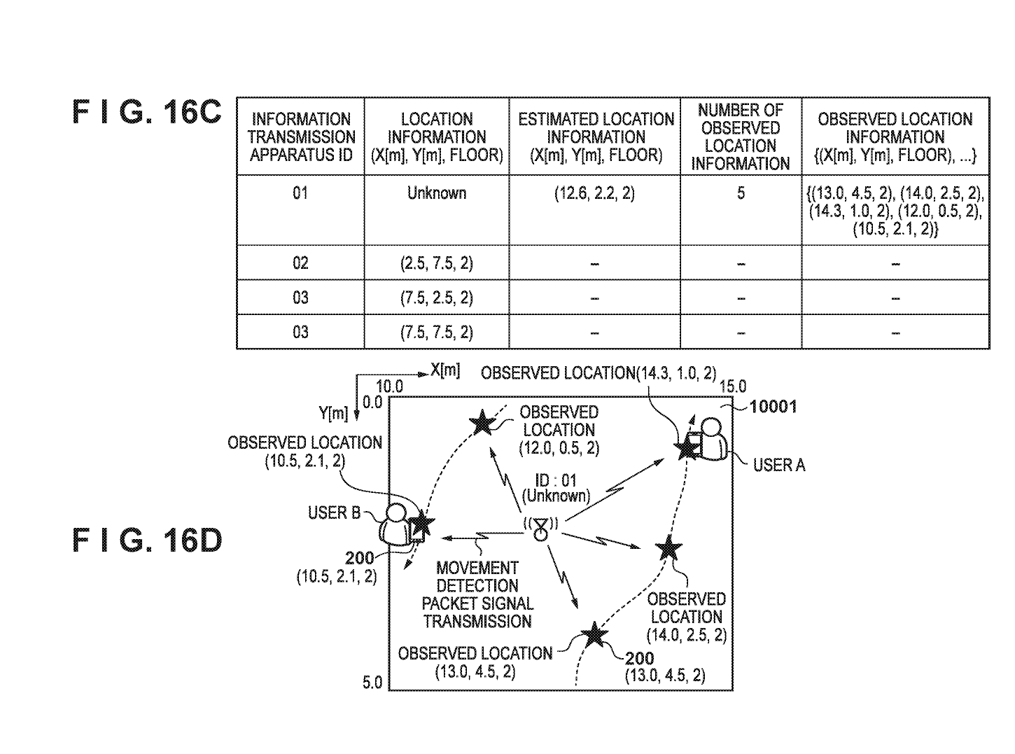

Processing of automatically estimating the location information of the information transmission apparatus 100 will be described with reference to FIGS. 14A to 16D. FIGS. 14A and 14B are flowcharts of beacon signal processing of a mobile terminal 200 and a management server 300 upon receiving a beacon signal. FIG. 15 is a flowchart of packet information processing of the management server 300. FIGS. 16A to 16D show examples of a beacon location database 354 of the management server 300, the arrangement image of the information transmission apparatuses 100 and the mobile terminal 200, and the self estimated location of the mobile terminal 200 and the past observed location of a beacon signal (that is, beacon signal reception location).

Steps S1401 to S1410 in the flowcharts of FIGS. 14A and 14B are implemented by causing a CPU 201 of the mobile terminal 200 to execute a program stored in a ROM 202. Steps S1411 to S1413 are implemented by causing a CPU 301 of the management server 300 to execute a program stored in a ROM 302. Steps S1402 to S1404, S1407 and S1408, and S1410 are the same as steps S901 to S903, and S906 to S908 of FIG. 9 described in the second embodiment, and a description thereof will be omitted here.

This embodiment is different from the second embodiment in that the self location of the mobile terminal 200 upon receiving the beacon signal is transmitted to the management server 300, and the location of the information transmission apparatus 100 whose location information is “Unknown” is estimated based on the collected self locations. This makes it possible to estimate the location of the information transmission apparatus 100 and notify the mobile terminal 200 of it.

In step S1401, the mobile terminal 200 calculates the self location by a self location calculation unit 257. The parameters of location information will be described here. In the first to third embodiments, the location information of the information transmission apparatus 100 is allocated to a rough section. From the fourth embodiment, however, coordinates on a horizontal plane are registered as the parameters of the location information to accurately estimate the location of the information transmission apparatus 100. For example, in FIGS. 16A to 16D, x and y components on an x-y plane are represented by distances [m] from a certain point (origin) in a building, which is defined as (0.0 [m], 0.0 [m]). However, even in the method of allocating location information to a section, the relative positional relationship between sections can be specified by associating the center coordinates of the sections with each other in advance. It is therefore possible to estimate a rough location by the method according to the fourth embodiment.

In step S1405, the mobile terminal 200 transmits the current location (that is, self location) of the mobile terminal 200 and the packet information of the information transmission apparatus 100 to the management server 300. More specifically, location information (13.0, 4.5, 2) is transmitted to the management server 300 as the current location. For example, assume that a user A comes close to the information transmission apparatus 100 that transmits a movement detection packet signal including an ID “01”, as shown in FIG. 16B. If the current location of the mobile terminal 200 that has received the movement detection packet signal is calculated as (13.0, 4.5, 2), the above-described current location is transmitted to the management server 300 together with the movement detection packet information.

In step S1406, the mobile terminal 200 receives return information from the management server 300 as a response to the information transmitted in step S1405. For example, return information when the mobile terminal 200 has received the movement detection packet signal is represented by “ID: 01, location information: Unknown, estimated location: (13.0, 4.5, 2), number of observed location information: 1”.

In step S1409, if the information transmission apparatus 100 is present within a predetermined range, the mobile terminal 200 updates the current location information of the mobile terminal 200. More specifically, if it is determined, based on the received radio field intensity measured in step S1403, that the information transmission apparatus 100 is present within a predetermined range (for example, 1 m), the location information in a location information storage unit 256 of the mobile terminal 200 is updated to the received location information of the information transmission apparatus 100.

In step S1411, the management server 300 causes a wired network transmission/reception unit 355 to perform reception processing of the current location information of the mobile terminal 200 and the packet information. The pieces of received information are sent to a packet information processing unit 352 by a main control unit 351. In step S1412, the management server 300 performs packet information processing. The process of this step will be described later with reference to FIG. 15. In step S1413, the management server 300 causes the wired network transmission/reception unit 355 to transmit the packet information processing result from the management server 300 to the mobile terminal 200. For example, “ID: 01, location information: Unknown, estimated location: (13.0, 4.5, 2), number of observed location information: 1” is transmitted as the processing result. The packet information processing result is received by the mobile terminal 200 as return information (step S1406).

Steps S1501 to S1508 in the flowchart of FIG. 15 are implemented by causing the CPU 301 of the management server 300 to execute a program stored in the ROM 302. Steps S1501 to S1504 are the same as steps S1001, S1002, S1004, and S1005 of FIG. 10 described in the second embodiment, and a description thereof will be omitted here. This embodiment is different from the second embodiment in that the location of the information transmission apparatus 100 whose location information is “Unknown” is estimated from the location of the mobile terminal 200.

In step S1505, the management server 300 updates the location information of the beacon of the corresponding ID in the beacon location database 354 to “Unknown”. For example, the location information corresponding to the ID “01” is updated, as shown in FIG. 16A.

In step S1506, the management server 300 updates the number of observed location information and observed location information in the beacon location database 354. More specifically, the number of observed location information and observed location information are represented by columns of FIGS. 16A and 16C. For example, assume that the user A first receives the movement detection packet signal of the information transmission apparatus 100 of the ID “01” in FIG. 16B. In this case, the location information in the row of the ID “01” is set to “Unknown”, and the observed location information is updated to the self location “(13.0, 4.5, 2)” of the mobile terminal 200, as shown in FIG. 16A. In addition, the number of observed location information is updated to “1”. Similarly, assume that the user A and a user B sequentially receive the movement detection packet signal of the information transmission apparatus 100 of the ID “01” in a location 10001 shown in FIG. 16D. The track of each user is indicated by a broken arrow. Each reception location (that is, beacon signal observed location (past observation history)) is indicated by ★ in FIG. 16D. In this case, the observed location information in the row of the ID “01” is sequentially time-serially updated to the self location of the mobile terminal 200 upon observing the signal, as shown in FIG. 16C. As a result, (13.0, 4.5, 2), (14.0, 2.5, 2), (14.3, 1.0, 2), (12.0, 0.5, 2), and (10.5, 2.1, 2) are recorded in this order. In addition, the number of observed location information is updated to “5”.

In step S1507, the management server 300 estimates the location of the information transmission apparatus 100 for the observed location information and updates the estimated location information. More specifically, the estimated location is calculated as the center of gravity of a polygon having the observed location information expressed as (x component, y component) as the apexes, and the estimated location information is updated to the calculated center of gravity. The center of gravity of the polygon can be calculated using a known method, and a detailed description thereof will be omitted here. In step S1508, the management server 300 returns the packet information processing result to the mobile terminal 200. For example, in FIG. 16A, “ID: 01, location information: Unknown, estimated location: (13.0, 4.5, 2), number of observed location information: 1” is returned as the processing result.

In the fourth embodiment, the location of the information transmission apparatus 100 whose location information is “Unknown” is estimated based on the self estimated location of the mobile terminal 200. Note that although how to use the estimated location information of the beacon notified to the mobile terminal 200 has not been specified above, for example, the information may be presented in place of preceding location information when the user inputs a location reset by the method according to the third embodiment. Alternatively, the information may be used by another application.

### Fifth Embodiment

The fifth embodiment of the present invention will be described. In the fourth embodiment, even if the location of the information transmission apparatus 100 is sufficiently estimated, the location information remains “Unknown” unless the user manually resets the movement detection flag of the information transmission apparatus 100. In the fifth embodiment, an example will be described in which a reset notification to the user is made to reset the estimated location information of an information transmission apparatus 100 whose location is sufficiently estimated as new location information. The difference from the fourth embodiment will mainly be described below.

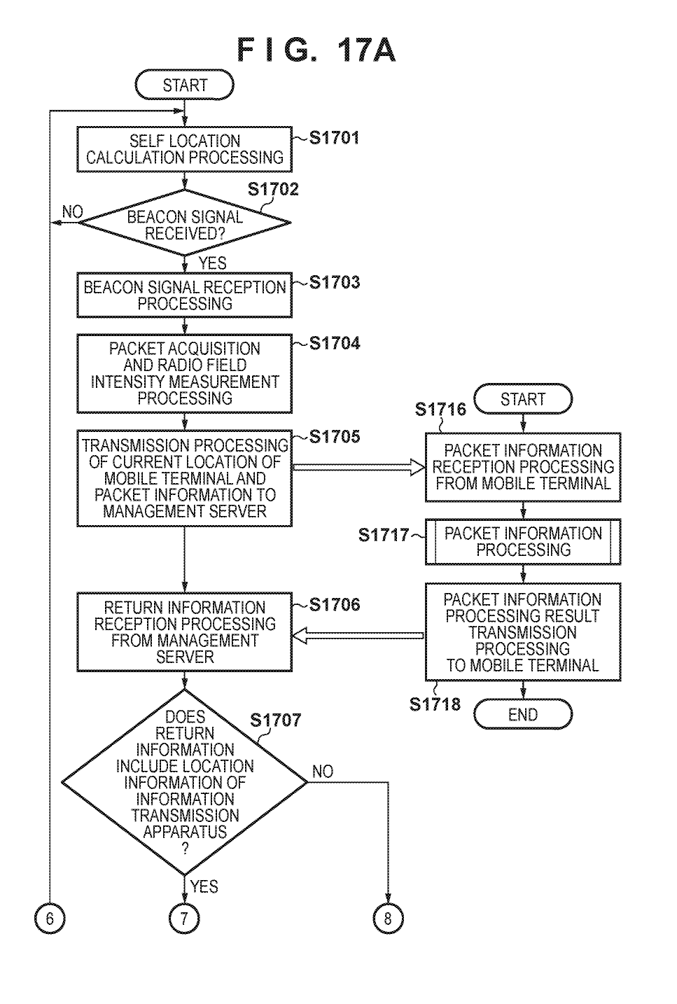

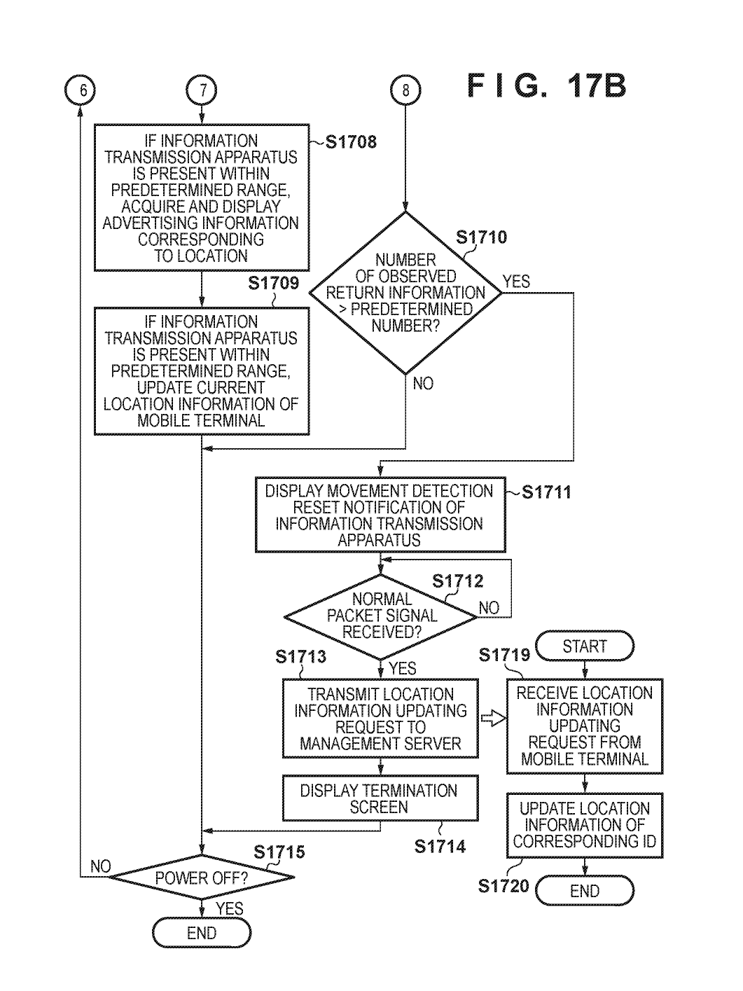

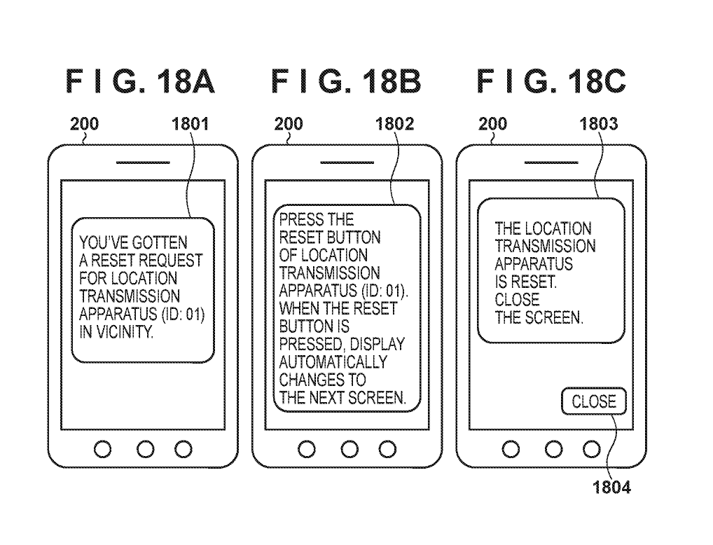

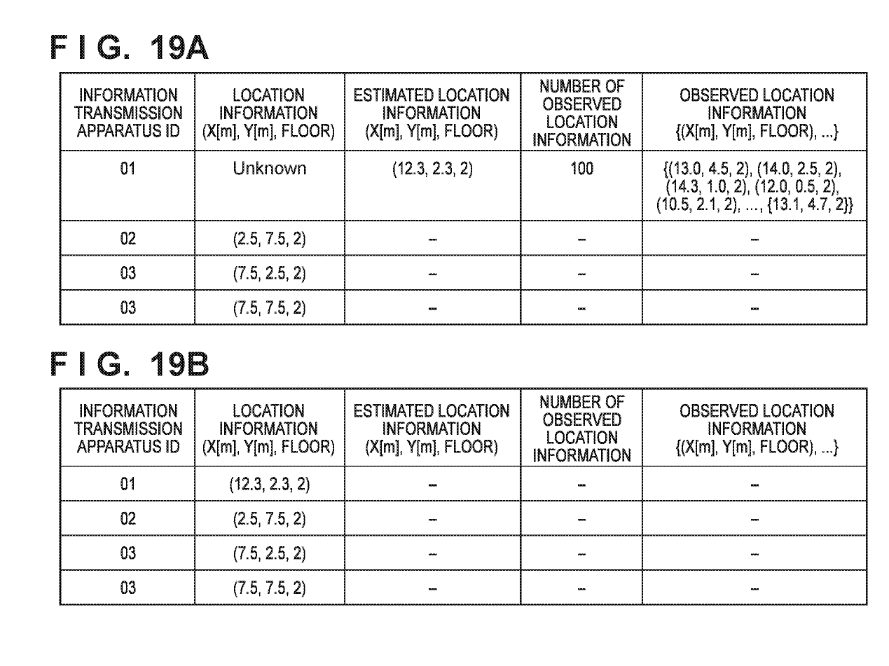

A method of resetting the location information of the information transmission apparatus 100 to an estimated location will be described with reference to FIGS. 17A to 19B. FIGS. 17A and 17B are flowcharts of beacon signal processing of a mobile terminal 200 and a management server 300 upon receiving a beacon signal. FIGS. 18A to 18C show an example of screen transition of the mobile terminal 200 of the user that receives the movement detection flag reset notification of the information transmission apparatus 100. FIGS. 19A and 19B show examples of a beacon location database 354 of the management server 300.

[Processing Procedure]

Steps S1701 to S1715 in the flowcharts of FIGS. 17A and 17B are implemented by causing a CPU 201 of the mobile terminal 200 to execute a program stored in a ROM 202. Steps S1716 to S1720 are implemented by causing a CPU 301 of the management server 300 to execute a program stored in a ROM 302. Steps S1701 to S1709, and S1715 to S1718 are the same as steps S1401 to S1413 described in the fourth embodiment, and a description thereof will be omitted here.

This embodiment is different from the fourth embodiment in that a reset notification to the user is made to reset the location information of the information transmission apparatus 100 whose location is sufficiently estimated as an estimated location. This makes it possible to change location information in the beacon location database 354 to the estimated location.

In step S1710, the mobile terminal 200 determines whether the number of observed location information in return information is larger than a predetermined number. For example, if the number of observed location information is 100 or more, as shown in FIG. 19A, it is determined that the number of observed location information is larger than a predetermined number. However, 100 is merely an example, and the predetermined number can be set to an arbitrary value. If the number of observed location information is larger than the predetermined number (YES in step S1710), the process advances to step S1711. If the number of observed location information is not larger (NO in step S1710), the process advances to step S1715.

In step S1711, the mobile terminal 200 displays, on a display module 206, a notification to prompt the user to reset the movement detection flag of the information transmission apparatus 100. For example, the reset notification pops up, like a display 1801 shown in FIG. 18A. If the notification is selected by a user's tapping operation, a message 1802 shown in FIG. 18B is displayed.

In step S1712, the mobile terminal 200 determines whether a normal packet signal is received from the information transmission apparatus 100 of the ID that has transmitted a movement detection packet signal till then. More specifically, when the user presses the reset button of the information transmission apparatus 100 that is transmitting the movement detection packet signal, a normal packet signal is received from the information transmission apparatus 100, and the screen shown in FIG. 18B transits to the next screen. Upon receiving a normal packet signal (YES ins step S1712), the process advances to step S1713. Otherwise, the processing waits until reception.

In step S1713, the mobile terminal 200 requests the management server 300 to set estimated location information input as new location information. For example, the mobile terminal 200 transmits “ID: 01, estimated location request: 1” as the location information updating request. In step S1714, the mobile terminal 200 displays a termination screen. For example, the mobile terminal 200 displays a screen 1803 shown in FIG. 18C. The user can close the termination screen by tapping a close button 1804.

In step S1719, the management server 300 receives the location information updating request transmitted from the mobile terminal 200 in step S1713. In step S1720, based on the ID included in the received location information updating request, the management server 300 updates the location information of the ID to the value of the estimated location information. More specifically, the location information “Unknown” shown in FIG. 19A is updated to estimated location information “(12.3, 2.3, 2)” shown in FIG. 19A, and the estimated location information, the number of observed location information, and the observed location information are updated to NULL. The beacon location database 354 after the updating is represented as shown in FIG. 19B.

In the fifth embodiment, an example has been described in which a beacon reset notification to the user is made to reset the estimated location information of the information transmission apparatus 100 whose location is sufficiently estimated as new location information. This can prompt the user to change the movement detection flag transmission state of the beacon whose location is sufficiently estimated to a normal packet transmission state.

### Sixth Embodiment

The sixth embodiment of the present invention will be described. In the second to fifth embodiments, an example has been described in which the information transmission apparatus 100 transmits the movement detection flag as additional information, and the management server 300 thus detects movement via the mobile terminal 200. The information transmission apparatus 100 operates with low power consumption and therefore performs only transmission processing to the outside. For this reason, to reset the movement detection flag, the user needs to directly press the reset button of the information transmission apparatus 100. In addition, only the same movement detection packet is transmitted until the movement detection flag is reset. Hence, even when movement is performed a plurality of times, it is impossible to detect it.

In the sixth embodiment, an example will be described in which a management server 300 detects the movement of an information transmission apparatus 100 not by the movement detection flag of the information transmission apparatus 100 but by a movement counter. When the movement count is held, the movement can always be detected without pressing the reset button of the information transmission apparatus 100. As a result, it is possible to improve the maintainability of the information transmission apparatus 100. The difference from the second and fourth embodiments will mainly be described.

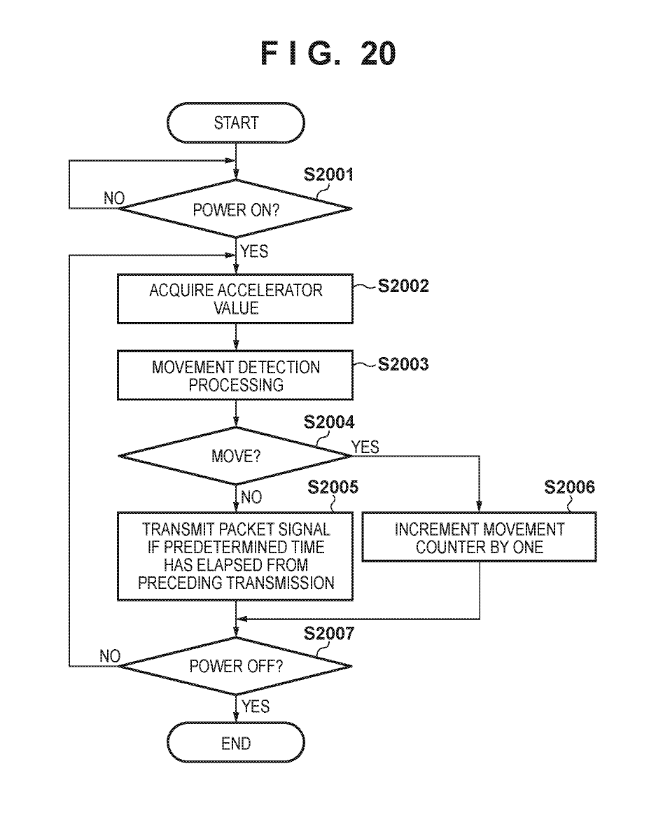

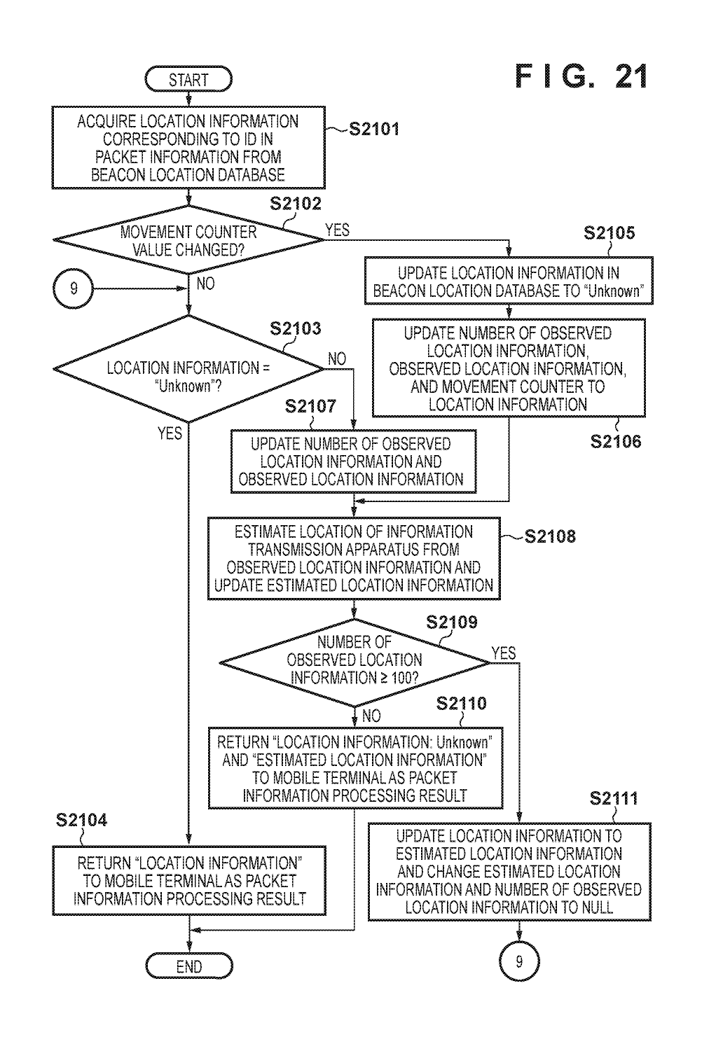

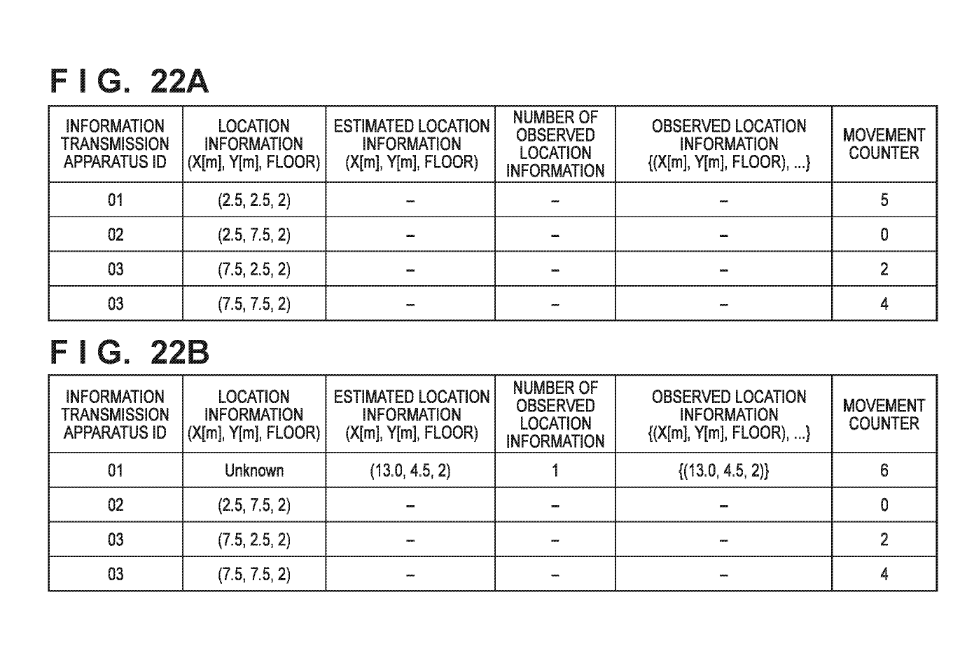

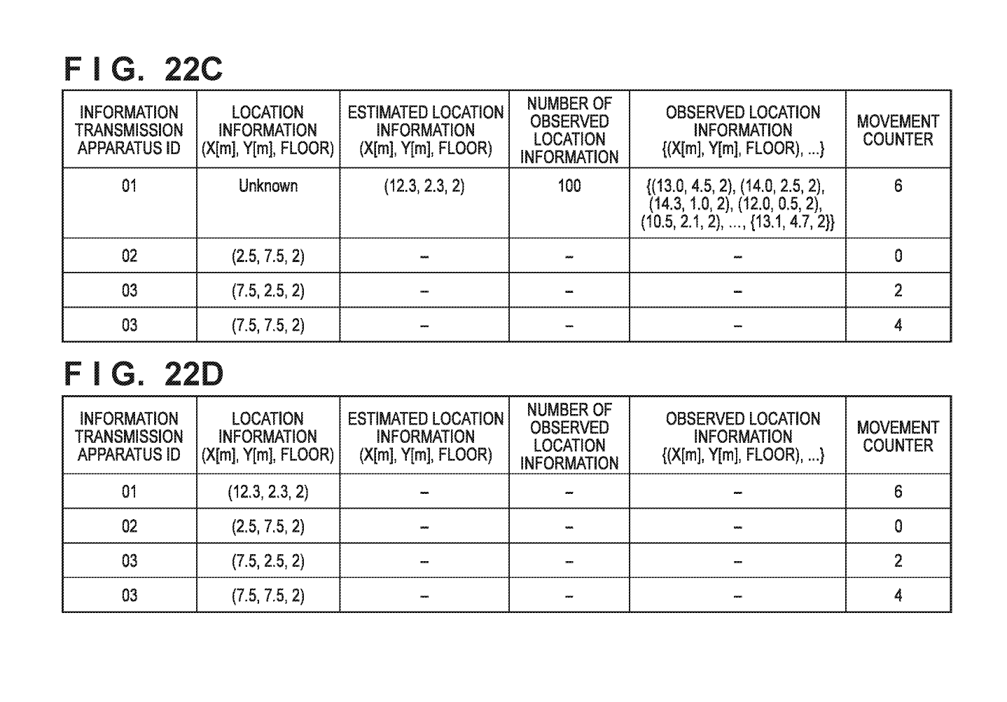

A method of detecting movement of the information transmission apparatus 100 using the movement counter will be described with reference to FIGS. 20 to 22D. FIG. 20 is a flowchart of the information transmission apparatus 100. FIG. 21 is a flowchart of packet information processing of the management server 300. FIGS. 22A to 22D show examples of a beacon location database 354 of the management server 300.

[Processing Procedure]

### (Processing of Information Transmission Apparatus)

Steps S2001 to S2007 in the flowchart of FIG. 20 are implemented by causing a CPU 101 of the information transmission apparatus 100 to execute a program stored in a ROM 102. Steps S2001 to S2004 and S2007 are the same as steps S801, S803 to S805, and S811 of FIG. 8 described in the second embodiment, and a description thereof will be omitted here. This embodiment is different from the second embodiment in that not the movement detection flag but the movement counter is used as additional information.

In step S2005, if a predetermined time has elapsed from preceding signal transmission, the information transmission apparatus 100 transmits a packet signal. For example, if a time of 1 sec or more has elapsed from preceding signal transmission in a case where the ID of the information transmission apparatus 100 is “01”, and movement is detected five times, a packet “ID: 01, movement counter: 5” including a movement counter as additional information is transmitted as an RF signal. The predetermined time “1 sec” is merely an example here, and the time can be set to an arbitrary value by a program. In step S2006, the information transmission apparatus 100 increments the original movement counter value by one upon detecting movement. The movement counter value reaches a predetermined counter value and then returns to “0”. The predetermined counter value is assumed to be, for example, “31”.

(Processing of Management Server)

Steps S2101 to S2111 in the flowchart of FIG. 21 are implemented by causing a CPU 301 of the management server 300 to execute a program stored in a ROM 302. Steps S2101, S2103 to S2105, S2107 and S2108, and S2110 are the same as steps S1501, S1502, and S1505 to S1508 of FIG. 15 described in the fourth embodiment, and a description thereof will be omitted here. This embodiment is different from the fourth embodiment in that a location in the beacon location database 354 is appropriately maintained based on a change in the movement counter value. The difference from the fourth embodiment will mainly be described below with reference to FIGS. 22A to 22D.

In step S2102, the management server 300 determines whether the movement counter value in the packet information of the information transmission apparatus 100 has changed. For example, if the movement counter value in the received packet information is “6” in a case where the movement counter corresponding to an ID “01” in the beacon location database 354 is “5”, it is determined that the movement counter value has changed. If the movement counter value has changed (YES in step S2102), the process advances to step S2105. If the movement counter value has not changed (NO in step S2102), the process advances to step S2103.

In step S2106, the management server 300 updates the number of observed location information, observed location information (that is, the location information of the mobile terminal 200), and the movement counter. For example, the database shown in FIG. 22A is updated as shown in FIG. 22B. The movement counter is updated to the movement counter value in the received packet information. The number of observed location information and the observed location information are the same as in the fourth embodiment, and a description thereof will be omitted here.

In step S2109, the management server 300 determines whether the number of observed location information is 100 or more. For example, in FIG. 22C, the number of observed location information corresponding to the ID “01” is determined to be 100 or more. The value of the number of observed location information is merely an example here, and any other value may be used. If the number of observed location information is 100 or more (YES in step S2109), the process advances to step S2111. If the number of observed location information is not 100 or more (NO in step S2109), the process advances to step S2110.

In step S2111, the management server 300 updates the location information of the ID to the value of the estimated location information. More specifically, the location information “Unknown” shown in FIG. 22C is changed to estimated location information “(12.3, 2.3, 2)” shown in FIG. 22C, and the estimated location information, the number of observed location information, and the observed location information are updated to NULL. The beacon location database 354 after the updating is represented as shown in FIG. 22D.

In the sixth embodiment, an example has been described in which the management server 300 detects the movement of the information transmission apparatus 100 not by the movement detection flag of the information transmission apparatus 100 but by the movement counter. This makes it possible to always detect movement on the side of the management server 300 without pressing the reset button of the information transmission apparatus 100.

### Other Embodiments

In the first embodiment, an example has been described in which the information transmission apparatus stops transmitting packet information upon detecting movement. In the second to sixth embodiments, an example has been described in which the movement of the information transmission apparatus is detected based on an accelerator sensor value by the information transmission apparatus 100, the mobile terminal 200, and the management server 300, and the value in the database is appropriately maintained. However, the movement may be detected based on not the value of the accelerator sensor but the value of another sensor. Not the sensor but, for example, a button that projects to the contact surface and detects movement may be used. In the above embodiments, the database is unitarily managed on the management server 300 such that a plurality of mobile terminals 200 can refer to the same database. However, the database may be held on a specific mobile terminal 200, and other terminals may refer to the database. Alternatively, the database on the management server 300 and the database on the mobile terminal 200 may always synchronize.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)′M), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-104515, filed May 20, 2014, which is hereby incorporated by reference herein in its entirety.

1.-20. (canceled)

21. A system including an information transmission apparatus and a mobile terminal,
said information transmission apparatus comprising:
transmission means for periodically transmitting identification information used to cause said mobile terminal to display predetermined information;
detection means for detecting that said information transmission apparatus has moved; and
stopping means for, when said detection means detects that said information transmission apparatus has moved, stopping transmission of the identification information by said transmission means, and
said mobile terminal comprising:
reception means for receiving the identification information; and
display means for displaying information corresponding to the identification information when said reception means receives the identification information.

22. The system according to claim 21, wherein said information transmission apparatus further comprises an accelerator sensor, and
said detection means detects, using said accelerator sensor, that said information transmission apparatus has moved.

23. The system according to claim 21, wherein said display means displays the information corresponding to the identification information when said reception means receives the identification information, and a distance between said mobile terminal and said information transmission apparatus is not more than a predetermined distance.

24. The system according to claim 21, wherein based on the identification information received by said reception means, said display means displays an advertisement of a store in which said information transmission apparatus is placed.

25. The system according to claim 24, wherein said mobile terminal further comprises acquisition means for acquiring, from an external apparatus, advertising information used to display the advertisement when said reception means receives the identification information, and
said display means displays the advertisement based on the advertising information.

26. A system including an information transmission apparatus and a mobile terminal,
said information transmission apparatus comprising:
transmission means for periodically transmitting identification information used to cause said mobile terminal to display predetermined information;
detection means for detecting that said information transmission apparatus has moved; and
change means for, when said detection means detects that said information transmission apparatus has moved, changing information to be periodically transmitted by said transmission means from the identification information to information representing that the information transmission apparatus has moved, and
said mobile terminal comprising:
reception means for receiving the identification information; and
display means for displaying information corresponding to the identification information when said reception means receives the identification information.

27. The system according to claim 26, wherein said information transmission apparatus further comprises an accelerator sensor, and
said detection means detects, using said accelerator sensor, that said information transmission apparatus has moved.

28. The system according to claim 26, wherein said display means displays the information corresponding to the identification information when said reception means receives the identification information, and a distance between said mobile terminal and said information transmission apparatus is not more than a predetermined distance.

29. The system according to claim 26, wherein based on the identification information received by said reception means, said display means displays an advertisement of a store in which said information transmission apparatus is placed.

30. The system according to claim 29, wherein said mobile terminal further comprises acquisition means for acquiring, from an external apparatus, advertising information used to display the advertisement when said reception means receives the identification information, and
said display means displays the advertisement based on the advertising information.

31. An information transmission apparatus comprising:
transmission means for periodically transmitting identification information used to cause a mobile terminal to display predetermined information;
detection means for detecting that the information transmission apparatus has moved; and
stopping means for, when said detection means detects that the information transmission apparatus has moved, stopping transmission of the identification information by said transmission means.

32. The apparatus according to claim 31, further comprising an accelerator sensor,
wherein said detection means detects, using said accelerator sensor, that the information transmission apparatus has moved.

33. An information transmission apparatus comprising:
transmission means for periodically transmitting identification information used to cause a mobile terminal to display predetermined information;
detection means for detecting that the information transmission apparatus has moved; and
change means for, when said detection means detects that the information transmission apparatus has moved, changing information to be periodically transmitted by said transmission means from the identification information to information representing that the information transmission apparatus has moved.

34. The apparatus according to claim 33, further comprising an accelerator sensor,
wherein said detection means detects, using said accelerator sensor, that the information transmission apparatus has moved.

35. A control method of an information transmission apparatus, comprising:
a transmission step of periodically transmitting identification information used to cause a mobile terminal to display predetermined information;
a detection step of detecting that the information transmission apparatus has moved; and
a stopping step of, when it is detected in the detection step that the information transmission apparatus has moved, stopping transmission of the identification information in the transmission step.

36. A storage medium storing a program that causes a computer to function as:
transmission means for periodically transmitting identification information used to cause a mobile terminal to display predetermined information;
detection means for detecting that the computer has moved; and
stopping means for, when said detection means detects that the computer has moved, stopping transmission of the identification information by said transmission means.

37. A control method of an information transmission apparatus, comprising:
a transmission step of periodically transmitting identification information used to cause a mobile terminal to display predetermined information;
a detection step of detecting that the information transmission apparatus has moved; and
a change step of, when it is detected in the detection step that the information transmission apparatus has moved, changing information to be periodically transmitted in the transmission step from the identification information to information representing that the information transmission apparatus has moved.

38. A storage medium storing a program that causes a computer to function as:
transmission means for periodically transmitting identification information used to cause a mobile terminal to display predetermined information;
detection means for detecting that the computer has moved; and
change means for, when said detection means detects that the computer has moved, changing information to be periodically transmitted by said transmission means from the identification information to information representing that the information transmission apparatus has moved.
